(19) United States
(12) Patent Application Publication
(10) Pub. No.: US 2026/0367805 A1
(43) Pub. Date: Nov. 19, 2026

(54) STORAGE SYSTEM AND METHOD FOR CONTROLLING STORAGE SYSTEM

(71) Applicant: Hitachi Vantara, Ltd., Yokohama-shi (JP)

(72) Inventors: Katsuto SATO, Tokyo (JP); Yoshinori OHIRA, Tokyo (JP); Taisuke ONO, Tokyo (JP)

(73) Assignee: Hitachi Vantara, Ltd., Yokohama-shi (JP)

(21) Appl. No.: 19/547,692

(22) Filed: Feb. 24, 2026

(30) Foreign Application Priority Data
May 13, 2025 (JP) 2025-080775

(51) Int. Cl. G06F 3/06

(52) U.S. Cl. CPC G06F 3/0619; G06F 3/0659; G06F 3/067

(57) ABSTRACT

When receiving a write request of data from the host, the storage controller of the storage system stores the data in the first storage drive, transfers the redundant data to another storage controller, and stores the redundant data in the second storage drive. In a case where a read request of data is received from the host when a failure does not occur in the first storage drive, the storage controller selects and performs one of: first read processing of reading data from the first storage drive and responding to the host; and second read processing of transferring the read request to the other storage controller and responding to the host using the redundant data read and transferred from the second storage drive by the other storage controller.

### BACKGROUND OF THE INVENTION

### 1. Field of the Invention

The present invention relates to a storage system and a method for controlling a storage system.

### 2. Description of the Related Art

A software defined storage (hereinafter SDS) in which a storage service is implemented by software in a general-purpose computer is a storage system having high flexibility of available hardware and excellent cost performance. The SDS can use the same function as the on-premises environment in the same procedure by developing the application area to the public cloud, and can perform data management in a unified procedure regardless of the environment.

However, in a public cloud environment, there is less freedom in hardware than in an on-premises environment, and an appropriate hardware configuration is selected and used from hardware configurations selected by a platform operator providing the cloud. In this case, for example, as in the case in which the upper limits of network (NW) bandwidth and backend storage (BE) bandwidth are determined according to the number of central processing unit (CPU) cores, hardware can only be selected from combinations subject to certain constraints, rather than from freely combinable options. In addition, since hardware cannot be changed in accordance with the use characteristics of software, a specific part becomes a bottleneck in performance, and the performance upper limit of the entire system may be restricted.

In addition, in the SDS, there is a strong tendency to frequently use the BE bandwidth due to the nature of providing the storage service, and there is a case where the performance of the entire system is restricted due to saturation of the BE bandwidth even in a situation where there is remaining capacity in the network bandwidth and the calculation capability of the CPU depending on the processing content. In addition, in a storage system including a plurality of computer nodes, when load concentrates on a specific node depending on the usage condition and the BE bandwidth is saturated, the performance of the entire system is restricted even if there is remaining capacity in the BE bandwidth or other nodes. As described above, when load concentrates on a specific node or BE bandwidth, the performance upper limit of the entire system may be limited while other available resources cannot be appropriately utilized.

Here, for example, JP 2024-151082 A discloses a conventional technique of improving performance by consuming burst credits for a node that temporarily requires a large number of resources in failure recovery such as rebuilding processing in a storage system having a plurality of nodes.

Further, for example, WO 2016/046970 A discloses a conventional technique in which, in a drive including a plurality of memory units, when it takes time to read data from a certain memory unit, a redundancy code calculated at the time of data storage is read from another memory unit and restoration processing is performed.

In addition, for example, JP 2024-098944 A discloses a conventional technique in which, when a load imbalance occurs between nodes in a storage system including a plurality of nodes, a volume experiencing concentrated access is virtually replicated to another node to distribute the load.

### SUMMARY OF THE INVENTION

However, the conventional technique disclosed in JP 2024-151082 A described above has a problem that the performance of the node can be improved only within the range of accumulated credits, and the improvement in performance is not continuous but limited. In addition, in the conventional technique disclosed in WO 2016/046970 A described above, although it is possible to achieve load distribution among memory units connected to the same drive controller, there is a problem that it is not possible to achieve load distribution among memory units of different drive controllers.

In addition, in the conventional technique disclosed in JP 2024-098944 A described above, since the BE bandwidth of the original node is consumed at the stage of virtual replication of the volume, there is a problem that the problem of BE bandwidth saturation is still not solved. In addition, it is possible to avoid the problem of BE bandwidth saturation by performing the performance rebalance processing and replicating the data to another node, but since the capacity of the storage area to be used is doubled, there is a problem that a trade-off problem between performance and cost occurs.

The present invention has been made in view of the above circumstances, and an object of the present invention is, in a storage system in which a cluster is configured by a plurality of nodes, to improve the performance of the entire storage system by balancing performance and cost and distributing the load on the BE bandwidth among the nodes.

To achieve the above object, the present invention provides, as one aspect, a storage system including a plurality of storage nodes communicably connected to a plurality of storage drives, in which each of the storage nodes includes a storage controller, in a case where the storage controller receives a write request of data from a host, the storage controller stores the data in a first storage drive of the storage drives and transfers redundant data of the data to another of the storage controllers, and the other storage controller stores the redundant data transferred from the storage controller in a second storage drive of the storage drives, in a case where a failure occurs in the first storage drive and a read request of data is received from the host, the other storage controller reads the redundant data from the second storage drive and transfers the redundant data to the storage controller, and the storage controller responds to the host using the transferred redundant data, and in a case where a read request of data is received from the host when a failure does not occur in the first storage drive, the storage controller selects and performs one of: first read processing of reading the data from the first storage drive and responding to the host; and second read processing of transferring the read request to the other storage controller and responding to the host using the redundant data of the data read and transferred from the second storage drive by the other storage controller in response to the read request.

According to the present invention, for example, in a storage system in which a cluster is configured by a plurality of nodes, it is possible to improve the performance of the entire storage system by balancing performance and cost and distributing the load on the BE bandwidth among the nodes.

### BRIEF DESCRIPTION OF THE DRAWINGS

FIG. 1 is a diagram illustrating a configuration and an operation outline of an entire system according to a first embodiment;

FIG. 2 is a diagram illustrating a configuration of hardware according to the first embodiment;

FIG. 3 is a diagram illustrating a data writing operation and a data retention status in a dual redundancy configuration according to the first embodiment;

FIG. 4 is a diagram illustrating a data reading operation at the time of failure in the dual redundancy configuration according to the first embodiment;

FIG. 5 is a diagram illustrating a data writing operation and a data retention status in a distributed dual redundancy configuration according to the first embodiment;

FIG. 6 is a diagram illustrating a data reading operation at the time of failure in the distributed dual redundancy configuration according to the first embodiment;

FIG. 7 is a diagram illustrating a data writing operation and a data retention status in the erasure code redundancy configuration according to the first embodiment;

FIG. 8 is a diagram illustrating a data reading operation at the time of failure in an erasure code redundancy configuration according to the first embodiment;

FIG. 9 is a diagram illustrating a configuration of a load balancer and an observer according to the first embodiment;

FIG. 10 is a diagram illustrating a configuration of the load balancer according to the first embodiment;

FIG. 11A is a flowchart illustrating processing of the load balancer according to the first embodiment;

FIG. 11B is a flowchart illustrating processing of a load balancer according to a first modification of the first embodiment;

FIG. 11C is a flowchart illustrating processing of a load balancer according to a second modification of the first embodiment;

FIG. 12 is a diagram illustrating a configuration of the observer according to the first embodiment;

FIG. 13 is a flowchart illustrating processing of the observer according to the first embodiment;

FIG. 14 is a diagram illustrating an outline of a parallel reading operation of the dual redundancy configuration according to the first embodiment;

FIG. 15 is a diagram illustrating an outline of a parallel reading operation of the distributed dual redundancy configuration according to the first embodiment;

FIG. 16 is a diagram illustrating an outline of a parallel reading operation of the erasure code redundancy configuration according to the first embodiment;

FIG. 17 is a diagram illustrating a data writing operation and a data retention status in a dual redundancy configuration according to a second embodiment;

FIG. 18 is a diagram illustrating a data reading operation at the time of failure in the dual redundancy configuration according to the second embodiment;

FIG. 19 is a diagram illustrating a configuration of a load balancer according to the second embodiment;

FIG. 20A is a flowchart illustrating processing of a load balancer according to the second embodiment;

FIG. 20B is a flowchart illustrating processing of a load balancer according to a first modification of the second embodiment;

FIG. 20C is a flowchart illustrating processing of a load balancer according to a second modification of the second embodiment;

FIG. 21 is a diagram illustrating an outline of a parallel reading operation of a dual redundancy configuration according to the second embodiment; and

FIG. 22 is a diagram illustrating an outline of a parallel reading operation of a dual redundancy configuration according to the second embodiment.

### DESCRIPTION OF THE PREFERRED EMBODIMENTS

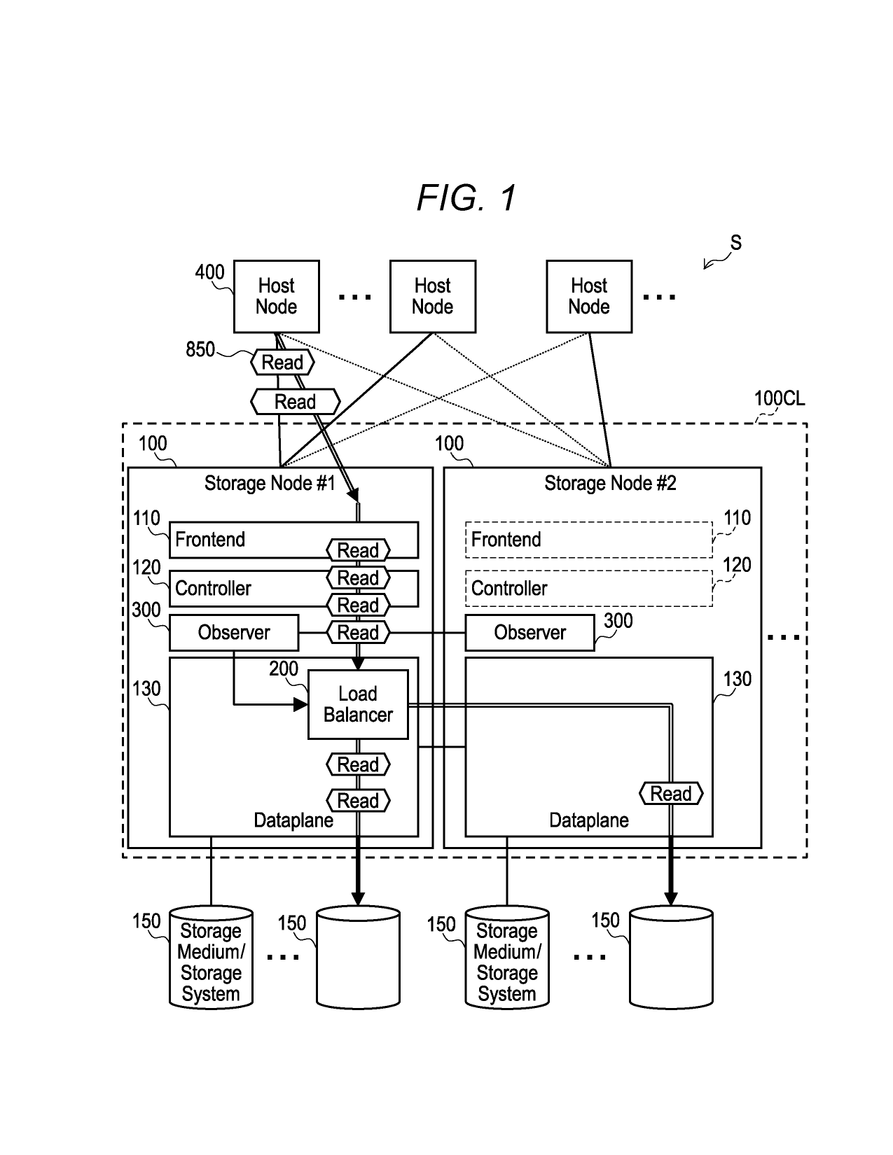

Hereinafter, an embodiment according to the present invention will be described in detail with reference to FIGS. 1-22. Note that the present invention is not limited by the following embodiments.

### First Embodiment

Configuration and outline of operation of entire system S according to first embodiment

FIG. 1 is a diagram illustrating a configuration and an operation outline of an entire system S according to a first embodiment. The entire system S includes a storage cluster 100CL, one or more storage media 150, and one or more host nodes 400. The storage cluster 100CL is an SDS cluster including a plurality of storage nodes 100. In the present embodiment, when a certain storage node 100 is referred to as a local node, storage nodes 100 other than the local node are referred to as other nodes.

The plurality of storage media 150 is an example of a plurality of storage drives such as a plurality of storage drives or a storage system connected to the storage node 100. The host node 400 outputs a read/write request to the storage node 100.

The storage node 100 includes a frontend block 110, a storage controller 120, a data plane function block 130, a load balancer 200, and an observer 300. The frontend block 110 receives a command from the host node 400. The storage controller 120 performs a storage process based on the command received by the frontend block 110. The data plane function block 130 performs redundancy of data and management processing of the storage medium 150. The load balancer 200 outputs an instruction to distribute the read request to other nodes so as to distribute the processing load on each storage node 100. The observer 300 observes and records the state of the storage node 100 and provides the observed state to the load balancer 200.

When receiving a read request from the host node 400, the storage node 100 normally performs an operation of reading data from the storage medium 150 connected to the local node. In contrast, when the backend bandwidth of the local node is saturated with reference to the observation result of the observer 300 and an occurrence of the performance constraint is detected, the load balancer 200 transfers the read request to another node in order to read data from the storage medium 150 connected to the other node. Data read by the other node is transferred to the storage node 100 that is the output source of the read request. The storage node 100 responds to the host node 400 without distinguishing data read by another node from data read from the storage medium 150 connected to the local node.

In the entire storage cluster 100CL, transfer processing of read data between the storage nodes 100 constitutes an additional processing load. Therefore, in a case where load is also applied to another node that is a transfer destination of the read request, the performance of the entire storage cluster 100CL will be degraded. Therefore, it is not appropriate for the load balancer 200 to simply divide and transfer the read request at a constant ratio. It is appropriate that the load balancer 200 transfers only an excessive read request in a case where the load on the local node is excessive and the load on another node is low according to a situation shared between the observers 300 existing in the respective storage nodes 100.

Configuration of hardware according to first embodiment

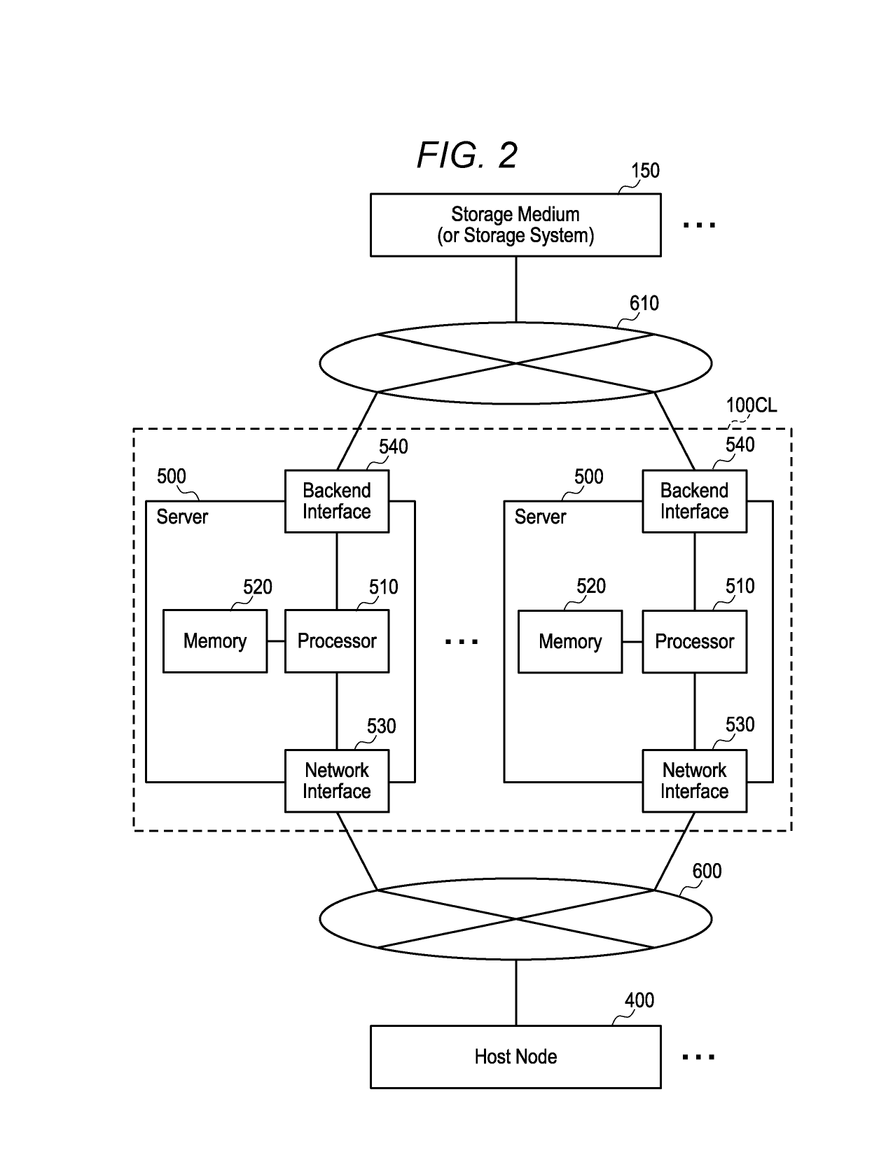

FIG. 2 is a diagram illustrating a configuration of hardware according to the first embodiment. The storage nodes 100 constituting the storage cluster 100CL are configured by server devices 500. Each server device 500 includes one or more processors 510, one or more memories 520, a frontend network interface 530, and a backend network interface 540. The frontend network interface 530 is a communication device for connecting the server device 500 to a frontend network 600 connected to the host node 400. The backend network interface 540 is a communication device for connecting to a backend network 610 such as a storage area network (SAN) connected to the storage medium 150.

The backend network 610 may be a different network for each server device 500, or may be the same network. Similarly, the storage medium 150 connected to the storage node server may be different for each server device 500, or may be the same. The host node 400 may have the same configuration as or a different configuration from the server device 500. The functional block constituting the storage node 100 may be realized by executing a program developed on the memory 520 by the processor 510 such as a central processing unit (CPU) or may be realized by using dedicated hardware.

In the first embodiment, in a storage system that redundantly stores data from a host node 400 in a storage medium 150, load balancing performed by the cooperation of a load balancer 200 and an observer 300 when load on a connection bandwidth with the storage medium 150 becomes excessive in a specific node will be described.

Data writing operation and data retention status in dual redundancy configuration according to first embodiment

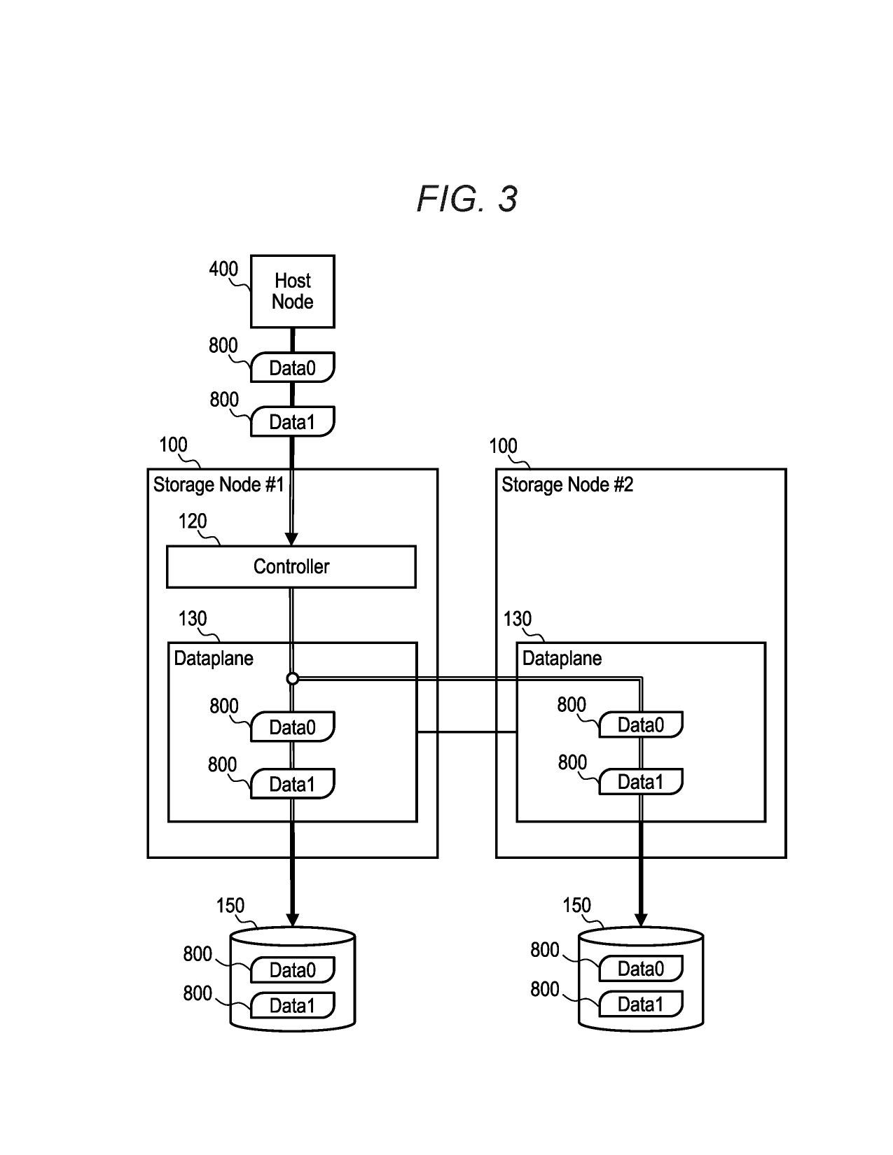

FIG. 3 is a diagram illustrating a data writing operation and a data retention status in the dual redundancy configuration (dual redundancy scheme) according to the first embodiment. In the dual redundancy scheme, data to be written is written and retained in two storage media, namely, a storage medium 150 connected to the storage node 100 that has received a write request, and a storage medium 150 connected to another node (standby node) that forms a data redundancy relationship with the storage node 100. In the present embodiment, dual redundancy is exemplified, but N-fold redundancy in which the same data is retained in N (N ≥ 3) storage media may be used.

Data reading operation at the time of failure in dual redundancy configuration according to first embodiment

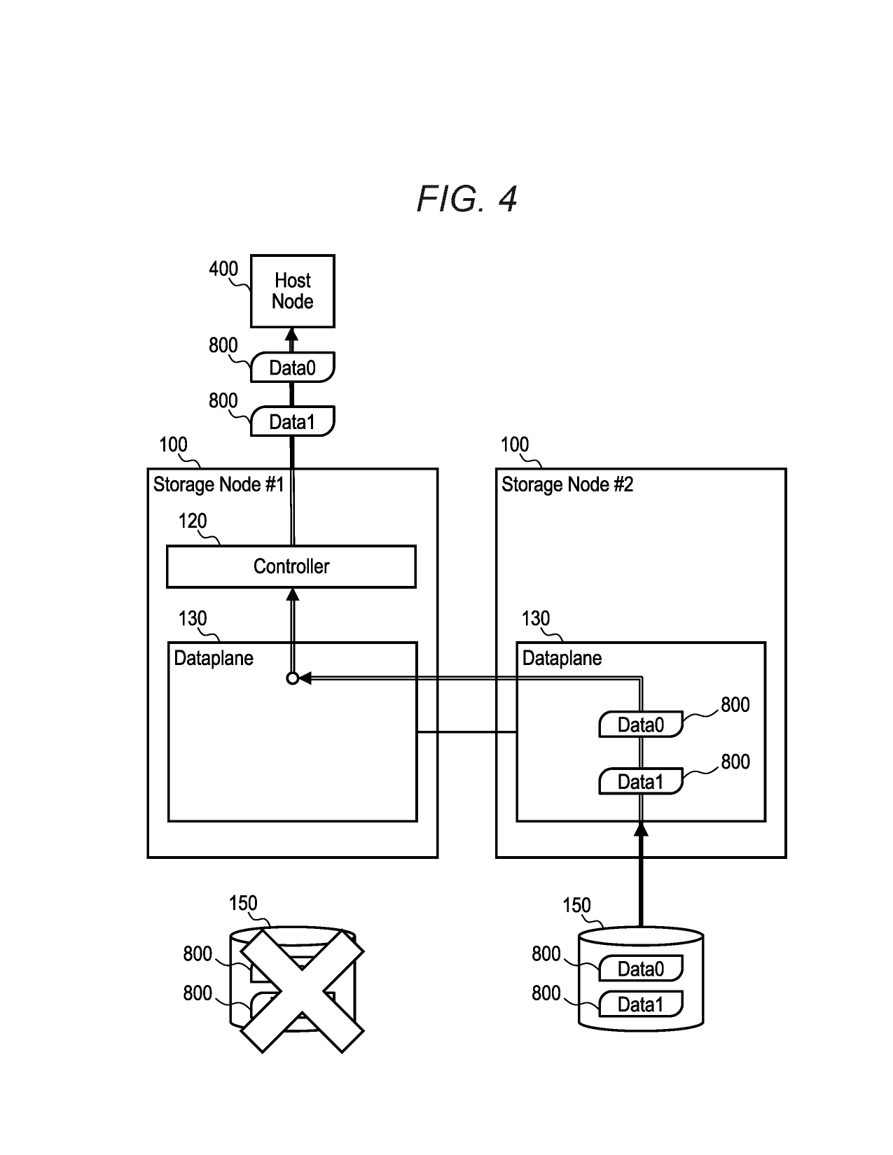

FIG. 4 is a diagram illustrating a data reading operation at the time of failure in the dual redundancy configuration according to the first embodiment. In a case where the storage node 100 (#1) cannot read data from the storage medium 150 connected to the local node when receiving a data read request from the host node 400, the storage node 100 (#1) transfers the read request to the storage node 100 (#2).

The storage node 100 (#2) reads redundant data retained in the storage medium 150 connected to the storage node 100 (#2), and transmits the redundant data to the storage node 100 (#1). The storage node 100 (#1) returns the read data received from the storage node 100 (#2) to the host node 400, so that the data reading can be continued even when the storage medium 150 connected to the storage node 100 (#1) fails.

Data writing operation and data retention status in distributed dual redundancy configuration according to first embodiment

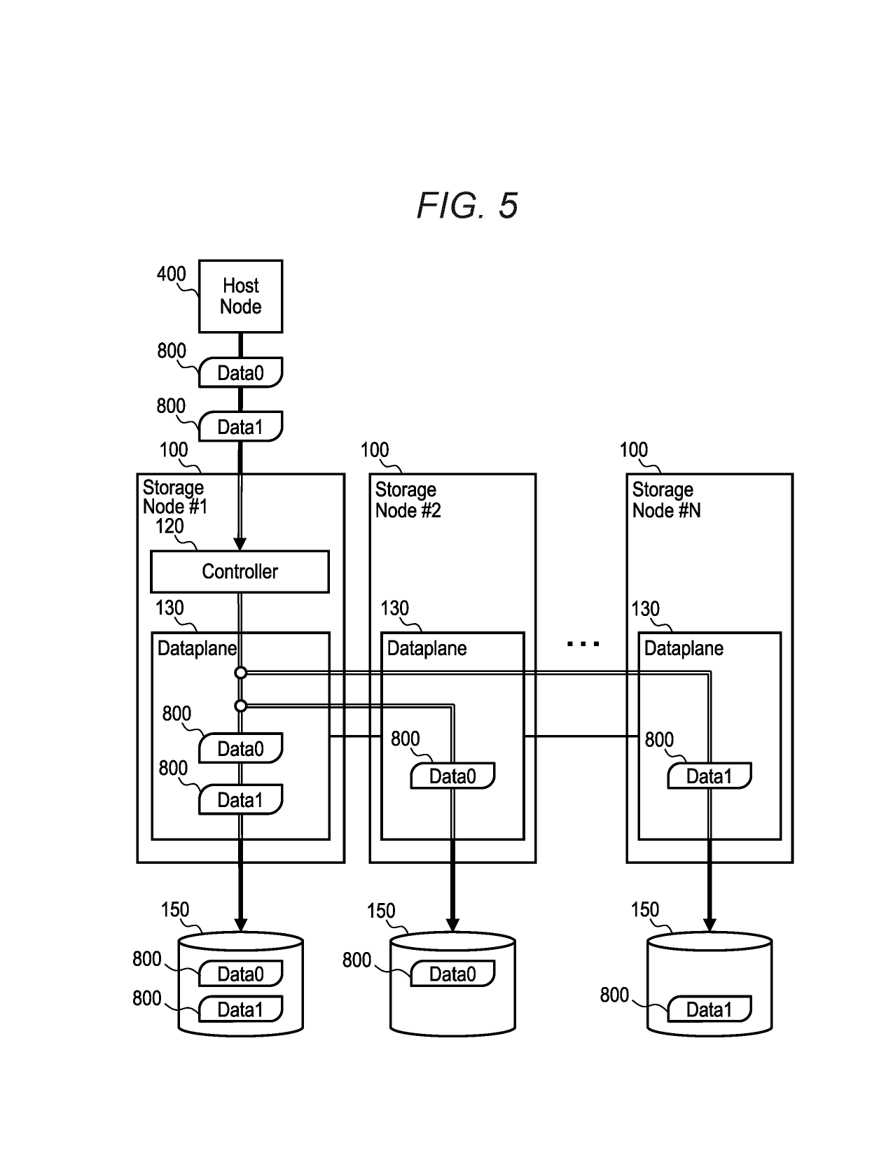

FIG. 5 is a diagram illustrating a data writing operation and a data retention status in a distributed dual redundancy configuration (distributed dual redundancy scheme) according to the first embodiment. In the distributed dual redundancy scheme, data is written and retained in the storage medium 150 connected to the storage node 100 that has received the write request and the storage medium 150 connected to another node forming a pair relationship with the storage node 100.

However, in the dual redundancy scheme of FIG. 3, a pair that redundantly retains data is fixed between specific storage nodes 100. In contrast, in the distributed dual redundancy scheme in FIG. 5, for example, storage nodes 100 and connected storage media 150 for redundantly retaining data are determined depending on a logical block address (Logical Block Address) specified when data is written, and the data is written accordingly. Alternatively, the write destination may be determined by another algorithm distributed to a plurality of storage nodes 100. Similarly, in the case of N-fold redundancy, storage destinations of the N pieces of identical data are determined according to a distributed algorithm, and the N pieces of identical data are stored in the storage medium 150 of the storage node 100 that has received the request and the storage media 150 of the other N-1 storage nodes 100.

Data reading operation at the time of failure in distributed dual redundancy configuration according to first embodiment

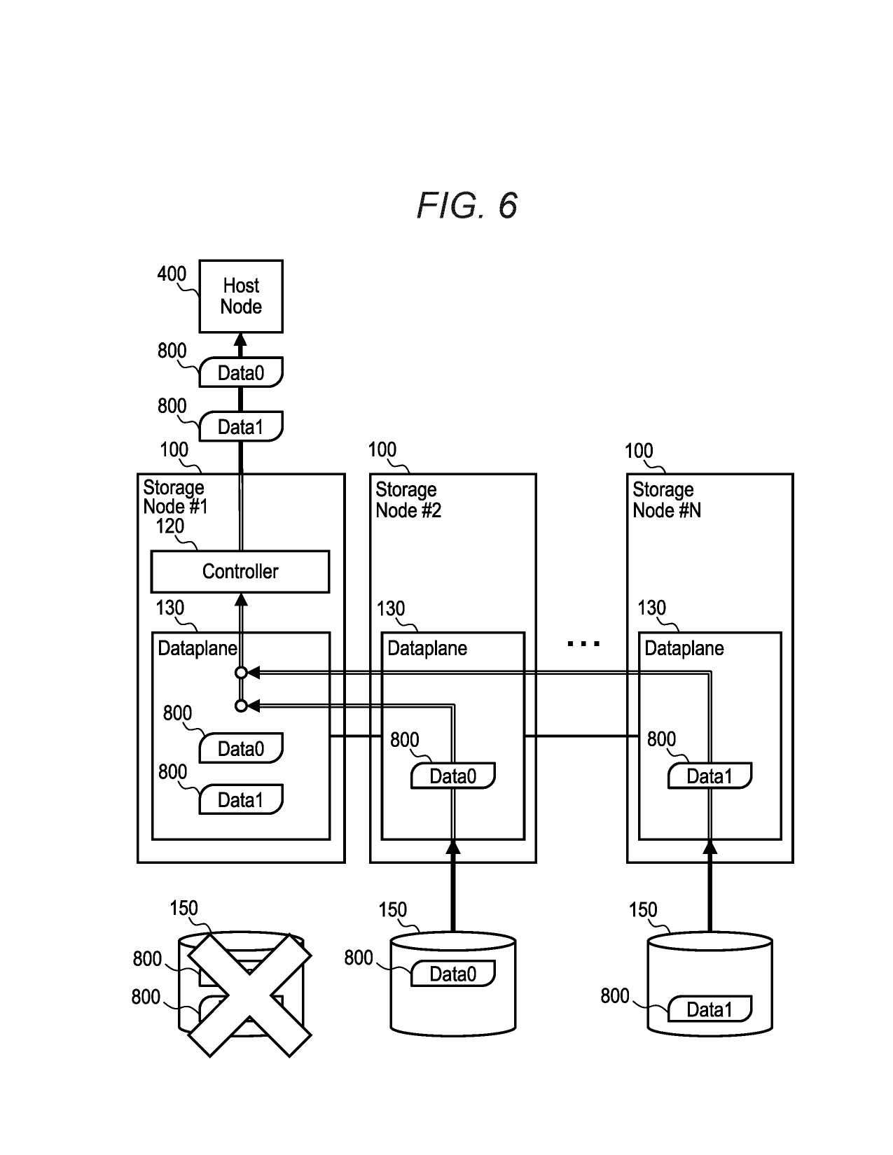

FIG. 6 is a diagram illustrating a data reading operation at the time of failure in the distributed dual redundancy configuration according to the first embodiment. Similarly to FIG. 4, in a case where the storage node 100 (#1) cannot read data from the storage medium 150

connected to the local node when receiving a data read request from the host node 400, the storage node (#1) transfers the read request to the storage node 100 (#2). However, the difference from FIG. 4 is that the storage node 100 (#2) to which the read request is transferred is the storage node 100 determined by the distribution algorithm at the time of writing.

In the distributed dual redundancy scheme, since the transfer destinations of the read request are distributed among all the other storage nodes 100, there is an advantage that the load per storage node 100 can be lowered. Also, in the rebuilding processing performed when the storage medium 150 of the storage node 100 is replaced, there is an advantage that reading of data can be distributed among the storage nodes 100 when redundantly retained data is written to the storage medium 150 of the local node.

Data writing operation in erasure code redundancy configuration according to first embodiment

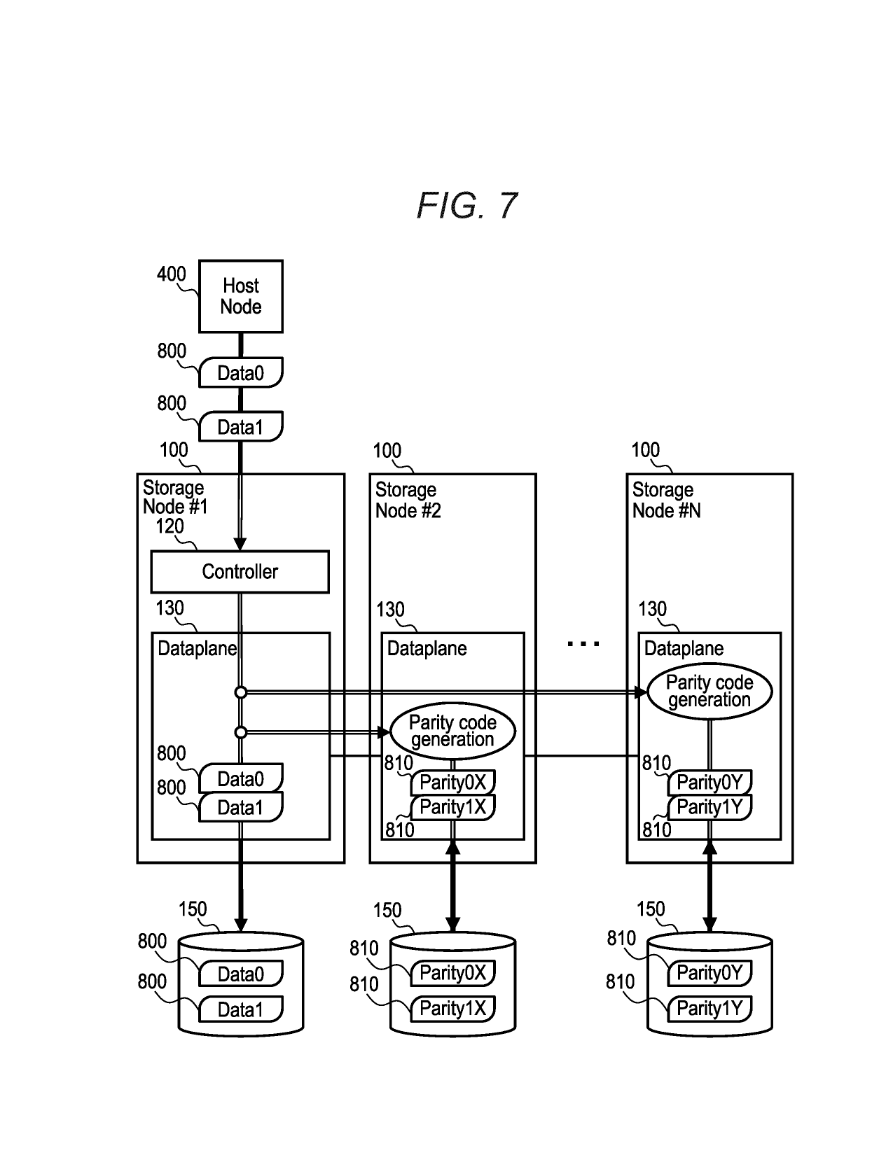

FIG. 7 is a diagram illustrating a data writing operation and a data retention status in the erasure code redundancy configuration according to the first embodiment.

In the erasure code redundancy configuration, data is written in the storage medium 150 after erasure coding of the data is performed. For example, data 800 is written as it is to the storage medium 150 connected to the storage node 100 that has received the data write request, and data (parity 810) subjected to erasure coding capable of restoring the original data 800 is written to another node.

For example, in the erasure coding redundancy scheme, n erasure codes are provided for every m data blocks, and the erasure codes are generated from the data blocks stored in the storage medium 150 of each storage node 100 and the data blocks stored in the storage medium 150 of another storage node 100. That is, the erasure coding redundancy scheme is a type of erasure coding (EC), namely mD + nP EC (Multi-stage EC), in which the total number of storage nodes 100 that perform data redundancy is (m + n) (where m and n are integers of 2 or more).

Data reading operation at the time of failure in erasure code redundancy configuration according to first embodiment

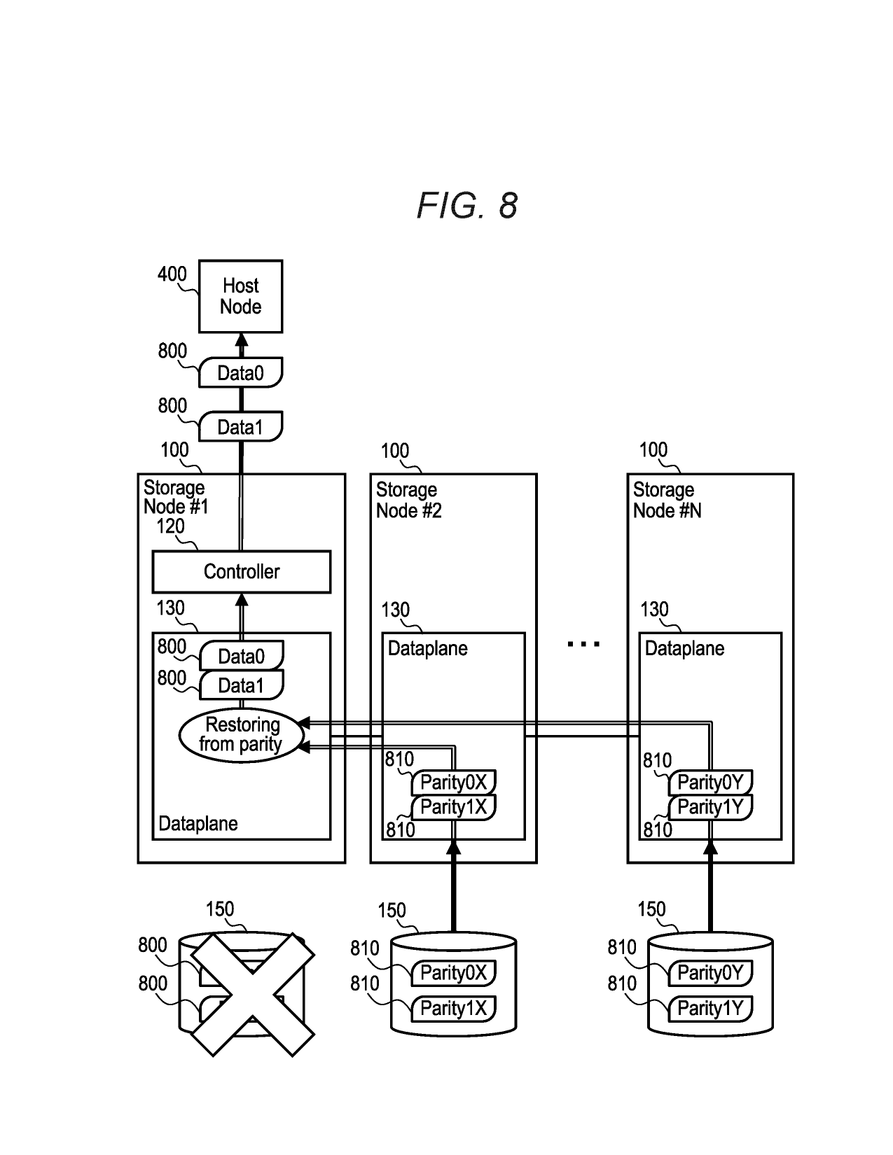

FIG. 8 is a diagram illustrating a data reading operation at the time of failure in the erasure code redundancy configuration according to the first embodiment. It is assumed that data 800 is written as it is in the storage medium 150 of the storage node 100 (#1) and is written as data (parity 810) obtained by performing erasure coding in each of the storage media 150 of the storage nodes 100 (#2 to #N). In this case, when a failure occurs in the storage medium 150 of the storage node 100 (#1), the data 800 cannot be read. However, the lost data 800 can be restored by collecting the data (parity 810) subjected to the erasure coding and performing the operation by a predetermined algorithm. The storage node 100 (#1) that has received the read request collects data or parity data necessary for restoring the data 800 from the storage node 100 (#2 to #N), restores the data 800 by performing a restoration operation, and responds to the host node 400.

With reference to FIGS. 3-8, representative data reading/writing and retaining methods in the storage cluster 100CL maintaining high availability and high reliability in the first embodiment have been described above. In general, the read or restore operation of the original data using the capability of another node consumes an extra operation capability from the viewpoint of the entire storage cluster 100CL, and thus, is performed only when necessary, such as when a failure occurs.

On the other hand, in a situation where other nodes have available computational capacity and the local node lacks backend bandwidth, data is read in cooperation with the other nodes regardless of whether a failure has occurred. As a result, the read performance of the specific storage node can be improved. Such an operation is hereinafter referred to as remote read processing.

The remote read processing is not always executable, and the remote read processing may cause performance degradation of another node depending on the load status of another node. Therefore, the load balancer 200 is provided, and the remote read processing needs to be executed only when it can be determined that there is a performance advantage by executing the remote read processing.

Configurations of load balancer 200 and observer 300 according to first embodiment

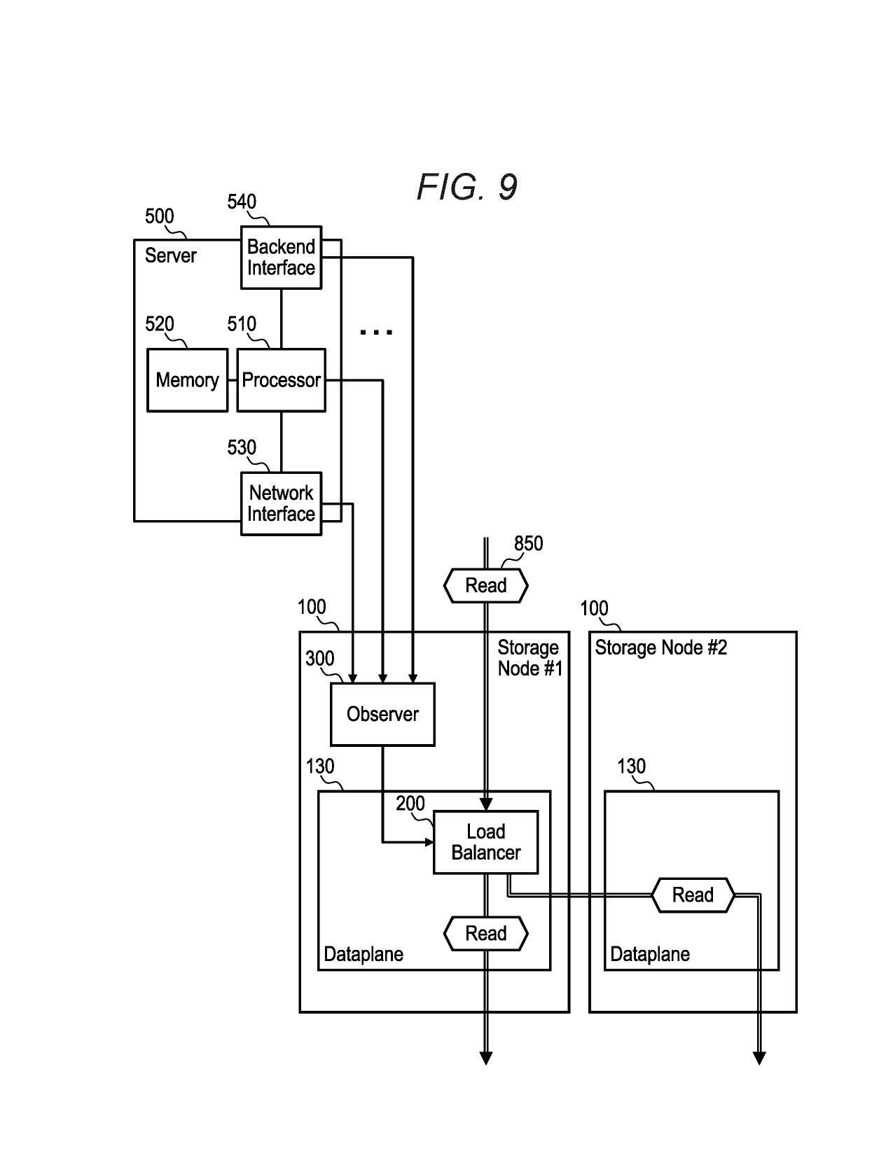

FIG. 9 is a diagram illustrating configurations of the load balancer 200 and the observer 300 according to the first embodiment. The load balancer 200 is disposed within the data plane function block 130 and receives a Read request issued to the data plane function block 130 from a storage controller or the like. The load balancer 200 determines whether to process the received Read request in the local node as usual or transfer the Read request to another node for processing on the basis of the load status obtained from the observer 300.

The observer 300 collects and retains load status information indicating a load status from various hardware elements. The observer 300 transmits the load status information to the load balancer 200 periodically or in response to a request from the load balancer 200.

The load status information may be a ratio of a busy time for each execution cycle or an average processing time in a specific program for the processor 510. In addition, the load status information may be, for the frontend network interface 530, a data transmission/reception amount per unit time with the frontend network 600, a usage rate with respect to a maximum data transmission/reception speed, an average communication delay time, or the like. In addition, the load status information may be, for the backend network interface 540, a data transfer amount per unit time with the storage medium 150 or the storage node 100 connected to the backend network 610, a usage rate with respect to the maximum transfer speed, the number of IO commands executed per unit time, a current usage rate with respect to the maximum number of IO commands executed per unit time, or the like.

Configuration of load balancer 200 according to first embodiment

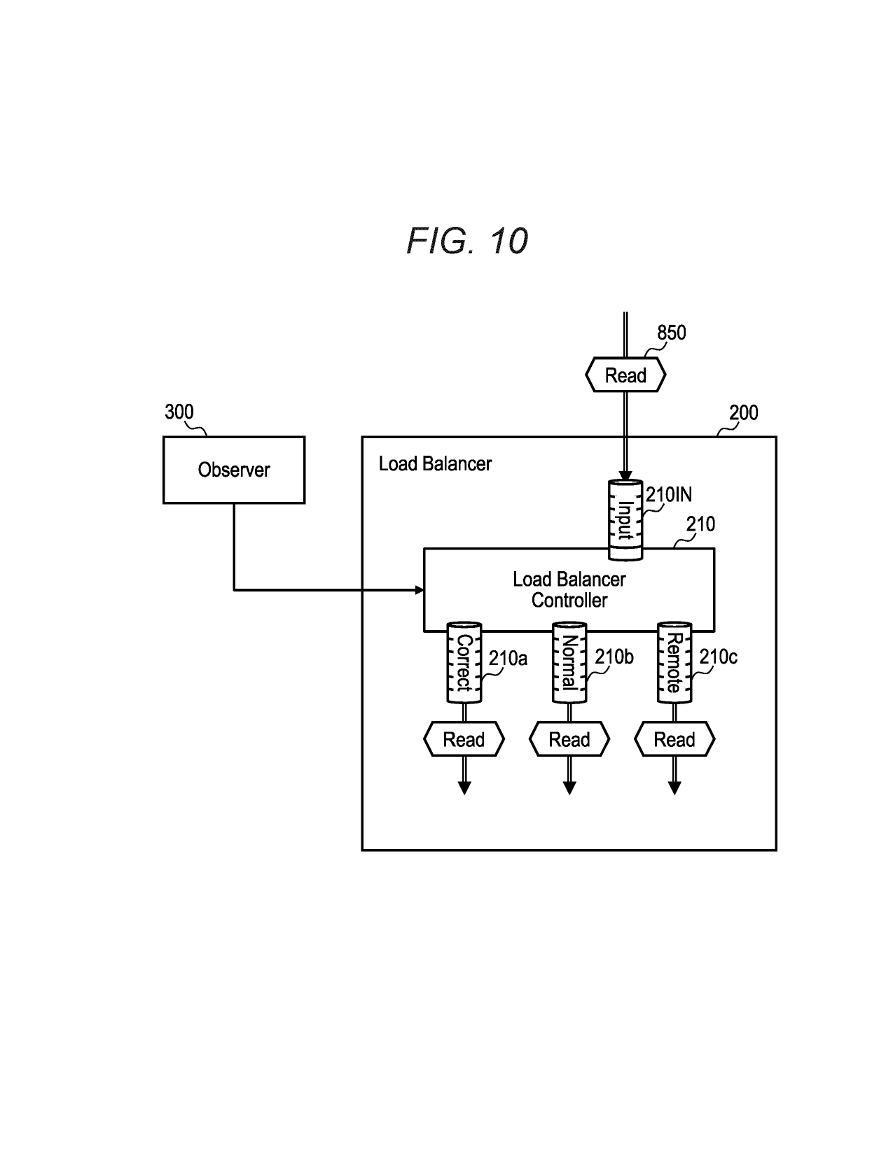

FIG. 10 is a diagram illustrating a configuration of the load balancer 200 according to the first embodiment. The load balancer 200 includes a load balancer controller 210. The load balancer controller 210 registers a read request arriving from the outside in an input queue 210IN of the load balancer controller 210. The load balancer controller 210 acquires the current load status information from the observer 300, determines a processing method of the read request based on the acquired load status information, and transfers the request to a correction read queue 210a, a normal read queue 210b, or a remote read queue 210c.

The read request registered in each queue is collected and executed by an appropriate function mounted on the data plane function block 130. For example, a read request registered in the correction read queue 210a is executed by the data plane function block 130 in a form of reading data redundantly stored in another node as a part of failure processing. The read request registered in the normal read queue 210b is executed by issuing a read request to the storage medium 150 of the local node. The read request registered in the remote read queue 210c is transferred to the normal read queue 210b of another node and executed in the other node. Then, the data read from the storage medium 150 connected to the other node is transferred to the local node.

Processing of load balancer 200 according to first embodiment

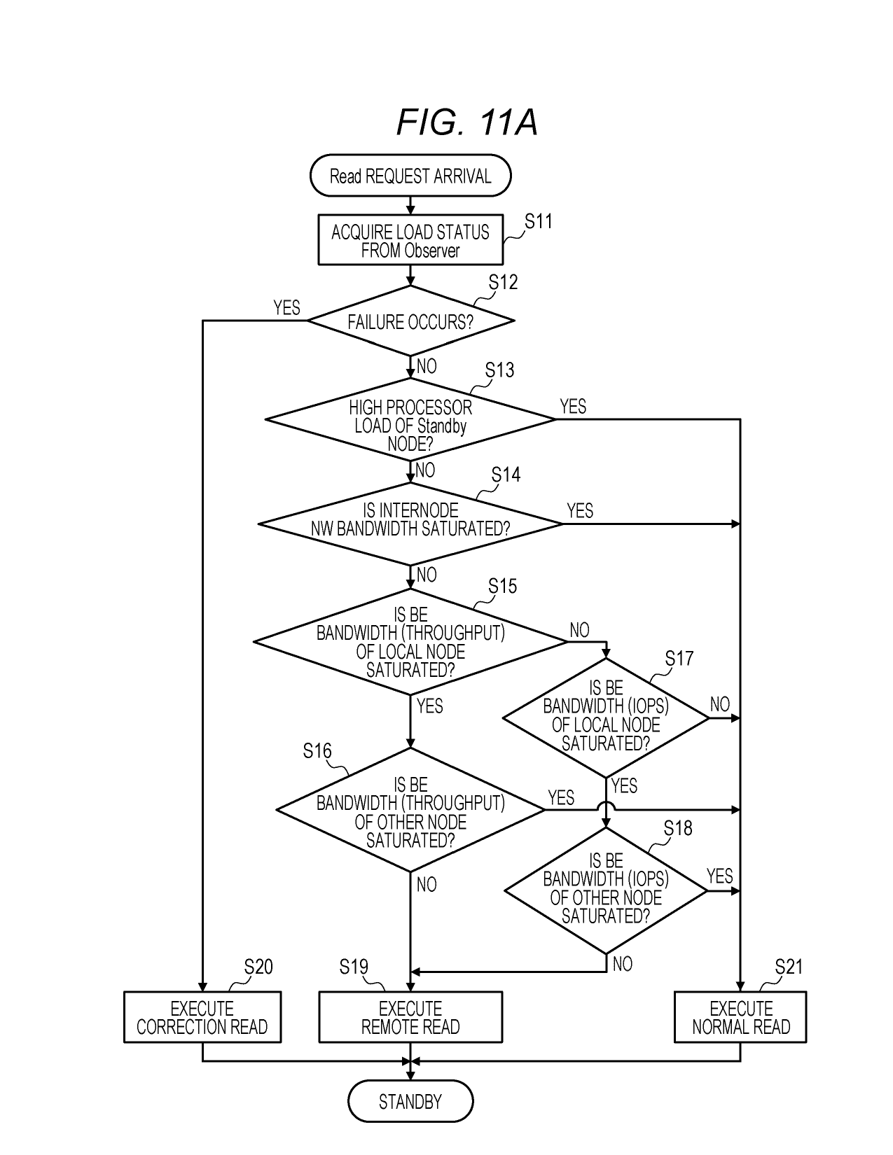

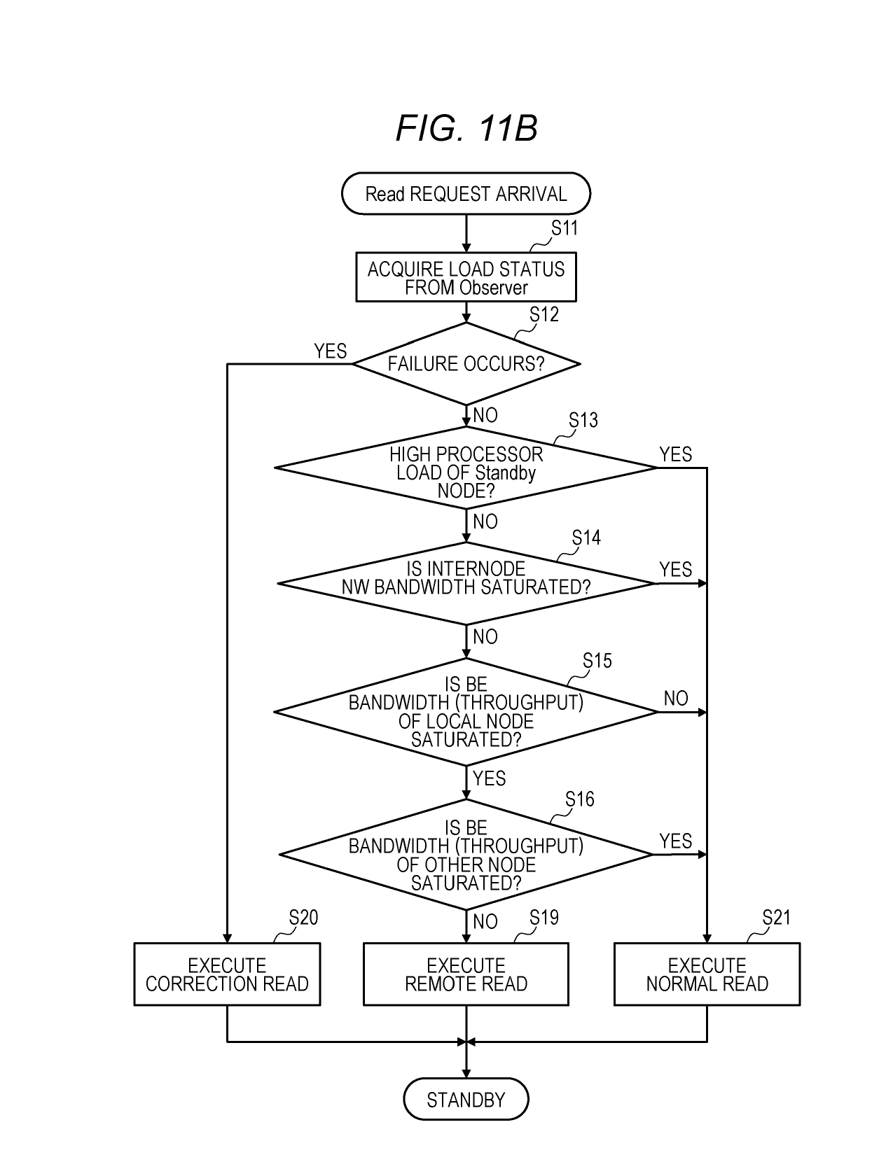

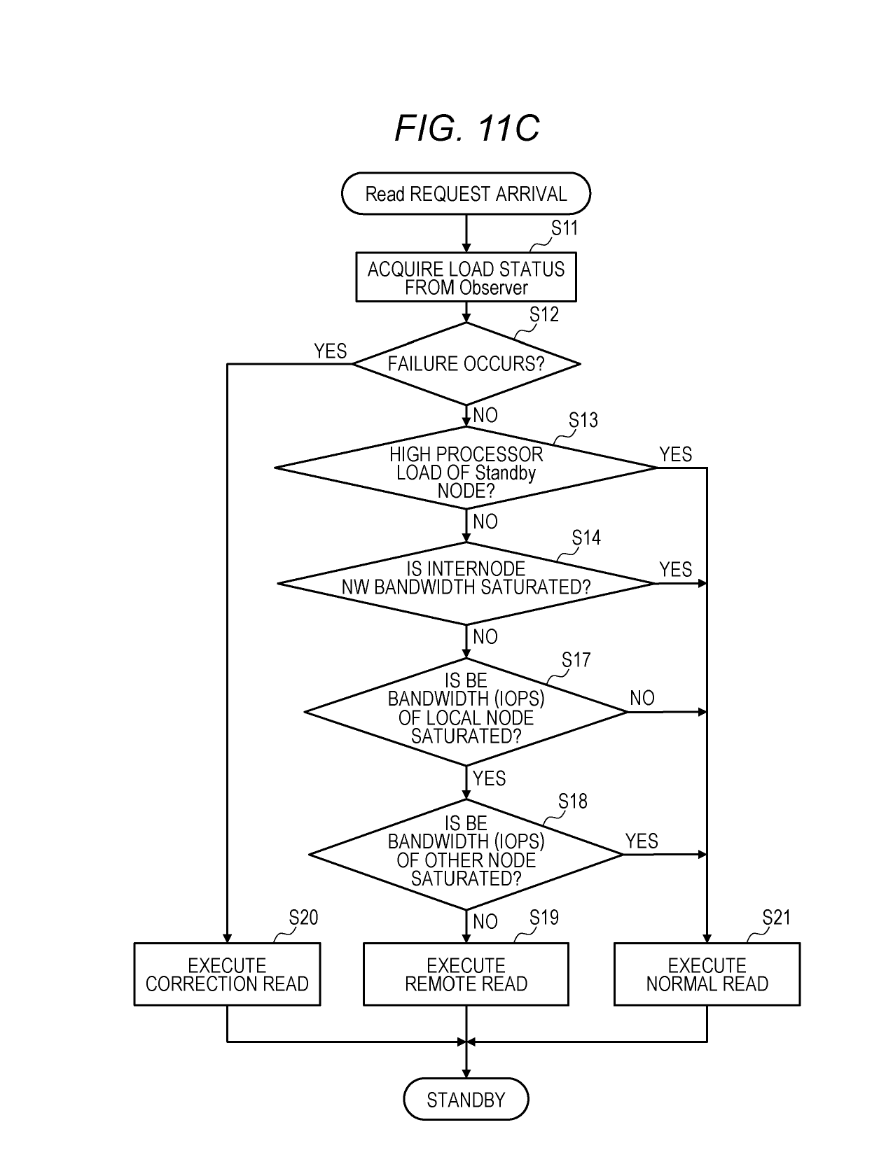

FIG. 11A is a flowchart illustrating processing of the load balancer 200 according to the first embodiment. Processing of the load balancer 200 is executed by the load balancer controller 210 of the load balancer 200 in response to arrival of a read request at the input queue 210IN.

First, in step S11, the load balancer controller 210 acquires load status information from the observer 300. Next, in step S12, the load balancer controller 210 refers to the load status information acquired in step S11, and determines whether data cannot be read from the storage medium 150 connected to the local node, that is, whether a fault state has occurred. When a failure has occurred (YES in step S12), the load balancer controller 210 moves the process to step S20. In contrast, when no failure has occurred (NO in step S12), the load balancer controller 210 moves the process to step S13.

In step S13, the load balancer controller 210 refers to the load status information acquired in step S11, and checks the processor load status of another node (Standby node) paired with the local node for data redundancy. When the processor load on the Standby node is greater than or equal to the threshold value (YES in step S13), the load balancer controller 210 moves the process to step S21. In contrast, when the processor load on the standby node is less than the threshold value (NO in step S13), the load balancer controller 210 moves the process to step S14.

In step S14, the load balancer controller 210 refers to the load status information acquired in step S11 and checks the network load status between the local node and the Standby node. When the network load on the standby node is greater than or equal to the threshold value (YES in step S14), the load balancer controller 210 moves the process to step S21. In contrast, when the network load on the standby node is less than the threshold value (NO in step S14), the load balancer controller 210 moves the process to step S15.

In step S15, the load balancer controller 210 refers to the load status information acquired in step S11 and checks the usage rate (throughput) of the backend bandwidth of the local node. The usage rate (throughput) of the backend bandwidth is a ratio of the amount of data actually processed to the amount of data that can be processed in one second.

When the usage rate (throughput) of the backend bandwidth of the local node is saturated to be equal to or higher than the threshold value (YES in step S15), the load balancer controller 210 moves the process to step S16. In contrast, when the usage rate (throughput) of the backend bandwidth of the local node is less than the threshold value and is not saturated (NO in step S15), the load balancer controller 210 moves the process to step S17.

In step S16, the load balancer controller 210 refers to the load status information acquired in step S11, and checks the usage rate (throughput) of the backend bandwidth of another node. When the usage rate (throughput) of the backend bandwidth of another node is saturated to be equal to or higher than the threshold value (YES in step S16), the load balancer controller 210 moves the process to step S21. In contrast, when the usage rate (throughput) of the backend bandwidth of another node is less than the threshold value and is not saturated (NO in step S16), the load balancer controller 210 moves the process to step S19.

In step S17, the load balancer controller 210 refers to the load status information acquired in step S11 and checks the command execution speed (IOPS) of the local node. The command execution speed (IOPS) is the number of IOs processed in a unit time (for example, one second).

If the command execution speed (IOPS) of the local node is saturated to be equal to or higher than the threshold value (YES in step S17), the load balancer controller 210 moves the process to step S18. In contrast, when the command execution speed (IOPS) of the local node is less than the threshold value and is not saturated (NO in step S17), the load balancer controller 210 moves the process to step S21.

In step S18, the load balancer controller 210 refers to the load status information acquired in step S11 and checks the command execution speed (IOPS) of another node. If the command execution speed (IOPS) of another node is saturated to be equal to or higher than the threshold value (YES in step S18), the load balancer controller 210 moves the process to step S21. In contrast, when the command execution speed (IOPS) of another node is less than the threshold value and is not saturated (NO in step S18), the load balancer controller 210 moves the process to step S19.

In step S19, the load balancer controller 210 registers the read command in the remote read queue 210c and returns to the standby state. In step S20, the load balancer controller 210 registers the read command in the correction read queue 210a and returns to the standby state. In step S21, the load balancer controller 210 registers the read command in the normal read queue 210b and returns to the standby state. The read commands registered in the correction read queue 210a, the normal read queue 210b, and the remote read queue 210c are sequentially executed.

Note that, in the processing of the load balancer 200 described above with reference to FIG. 11A, the throughput and the IOPS are determined for the usage rates of the backend bandwidths of the storage nodes 100 of both the local node and the other node. However, the present invention is not limited thereto, and the usage rate of the backend bandwidth of the local node and the other node may be determined by only one of the throughput and the IOPS. The usage rates of the backend bandwidths of the local node and the other node will be described with reference to FIGS. 11B and 11C with the determination of only the throughput as a first modification of the first embodiment and the determination of only the IOPS as a second modification of the first embodiment.

FIG. 11B is a flowchart illustrating processing of the load balancer 200 according to the first modification of the first embodiment. In the processing of the load balancer 200 according to the first modification of the first embodiment, steps S17 and S18 are omitted as compared with the processing of the load balancer 200 illustrated in FIG. 11A. Then, the load balancer 200 moves the process to step S16 in a case of YES in step S15, and moves the process to step S21 in a case of NO in step S15. In addition, the load balancer 200 moves the process to step S21 in a case of YES in step S16, and moves the process to step S19 in a case of NO in step S16. The processing of the load balancer 200 according to the first modification of the first embodiment is similar to the processing of the load balancer 200 according to the first embodiment in other respects.

FIG. 11C is a flowchart illustrating processing of the load balancer 200 according to the second modification of the first embodiment. In the processing of the load balancer 200 according to the second modification of the first embodiment, steps S15 and S16 are omitted as compared with the processing of the load balancer 200 illustrated in FIG. 11A. In a case of NO in step S14, the load balancer 200 moves the process to step S17. The load balancer 200 moves the process to step S18 in a case of YES in step S17, and moves the process to step S21 in a case of NO in step S17. In addition, the load balancer 200 moves the process to step S21 in a case of YES in step S18, and moves the process to step S19 in a case of NO in step S18. The processing of the load balancer 200 according to the second modification of the first embodiment is similar to the processing of the load balancer 200 according to the first embodiment in other respects.

Configuration of observer 300 according to first embodiment

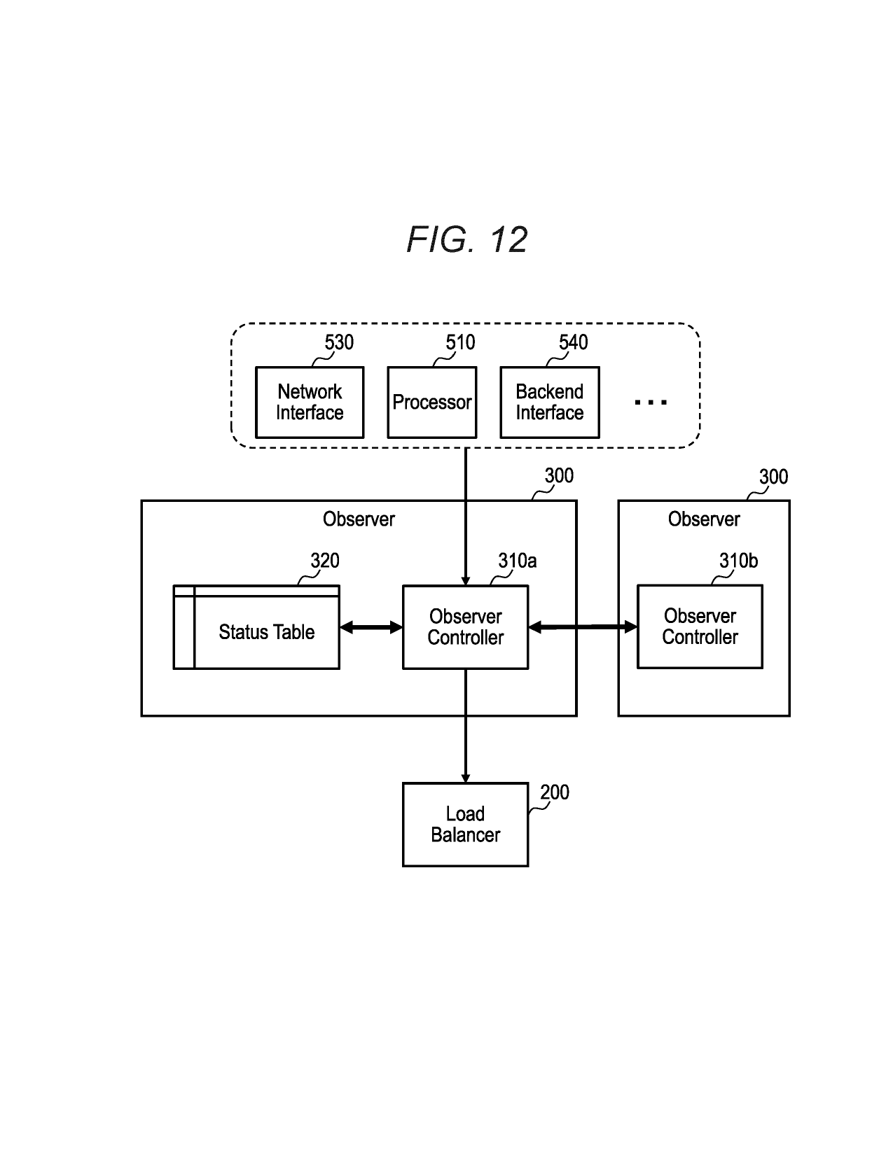

FIG. 12 is a diagram illustrating a configuration of an observer 300 according to the first embodiment. The observer 300 includes an observer controller 310a and a load status table 320. The observer controller 310aperiodically acquires load status information from a hardware element (a processor 510, a frontend network interface 530, a backend network interface 540, and the like) mounted on the local node, and writes the load status information in the load status table 320. This periodic operation is executed at regular time intervals using, for example, a timer. In addition, the load status information of the local node is transmitted to an observer controller 310b in the observer 300 existing in another node, and the load status information of the other node is received to exchange the load status information. The load status information accumulated in the load status table 320 is transmitted to the load balancer 200 periodically or in response to a request from the load balancer 200.

Processing of observer 300 according to first embodiment

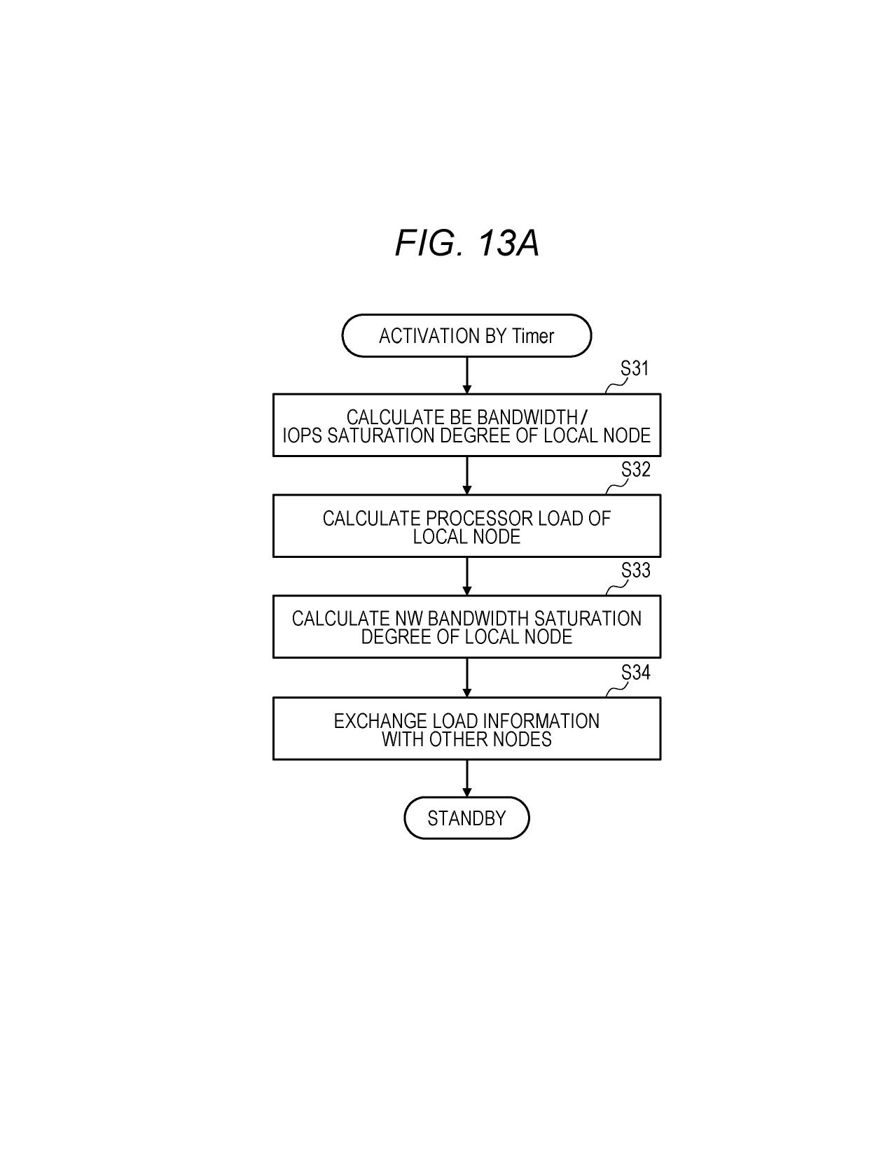

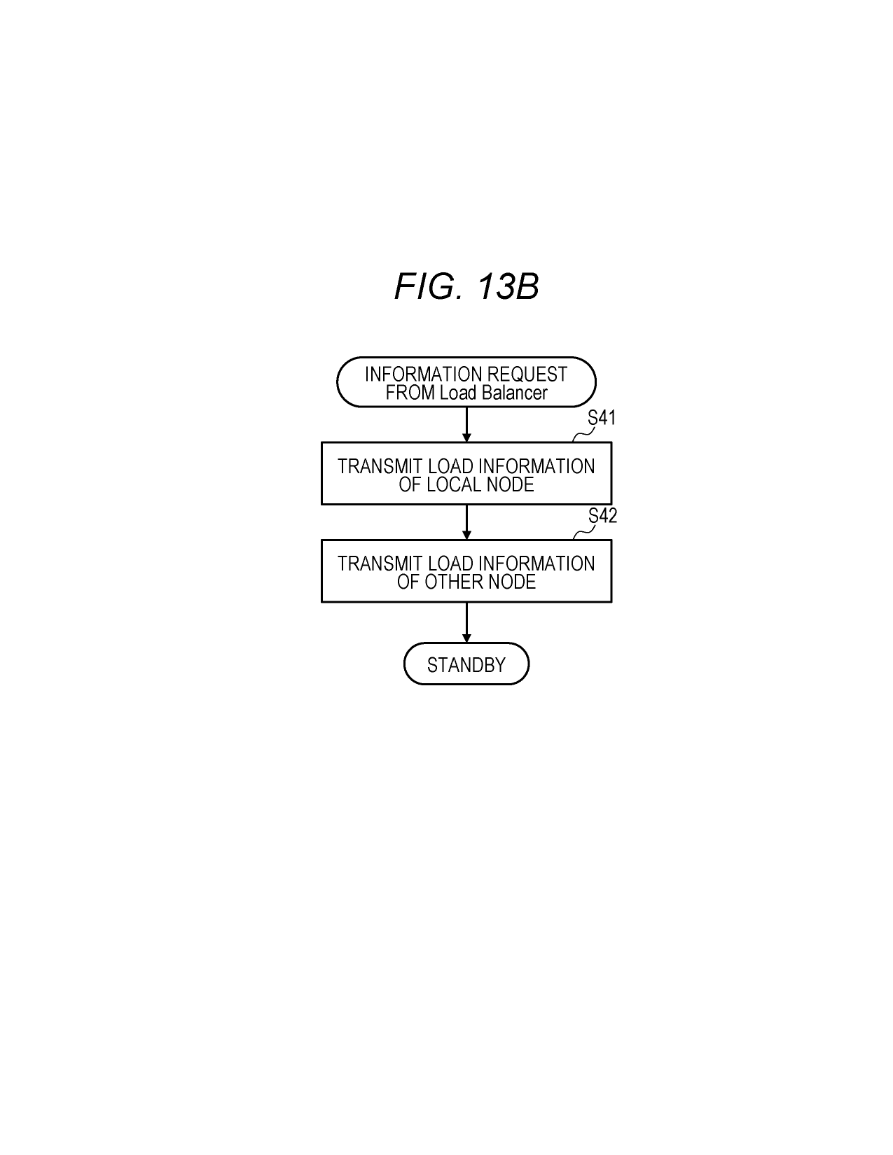

FIGS. 13A and 13B are flowcharts illustrating processing of the observer 300 according to the first embodiment. FIG. 13A illustrates processing executed by the observer 300 in response to a periodic start instruction by a timer or the like.

First, in step S31, the observer 300 acquires the usage status of the transfer bandwidth and the load status information of the number of executed IO commands per unit time from the backend network interface 540 of the local node. Then, the observer 300 calculates the degree of saturation from the relationship between the maximum transfer bandwidth and the maximum number of IO commands executed per unit time, and writes the degree of saturation in the load status table 320.

Next, in step S32, the observer 300 acquires the usage status information of the processor from the processor 510 of the local node, calculates the processor load, and writes the processor load in the load status table 320. Next, in step S33, the observer 300 acquires the usage status information of the transfer bandwidth from the frontend network interface 530 of the local node, calculates the NW bandwidth saturation degree from the relationship with the maximum transfer bandwidth, and writes the NW bandwidth saturation degree in the load status table 320.

Next, in step S34, the observer 300 transmits the load status information of the local node stored in the load status table 320 of the local node to the observer controller 310 in the observer 300 of another node, receives the load status information of the other node stored in the load status table 320 of the other node, and writes the load status information in the load status table 320 of the local node. When step S34 ends, the observer 300 returns to the standby state.

In addition, FIG. 13B illustrates processing executed by the observer 300 in response to a request from the load balancer 200 or a periodic start instruction by a timer or the like. First, in step S41, the observer 300 reads the load status information of the local node stored in the load status table 320 and transmits the load status information to the load balancer 200. Next, in step S42, the observer 300 reads the load status information of another node stored in the load status table 320, and transmits the load status information to the load balancer 200. When step S42 ends, the observer 300 returns to the standby state.

Parallel reading operation of dual redundancy configuration according to first embodiment

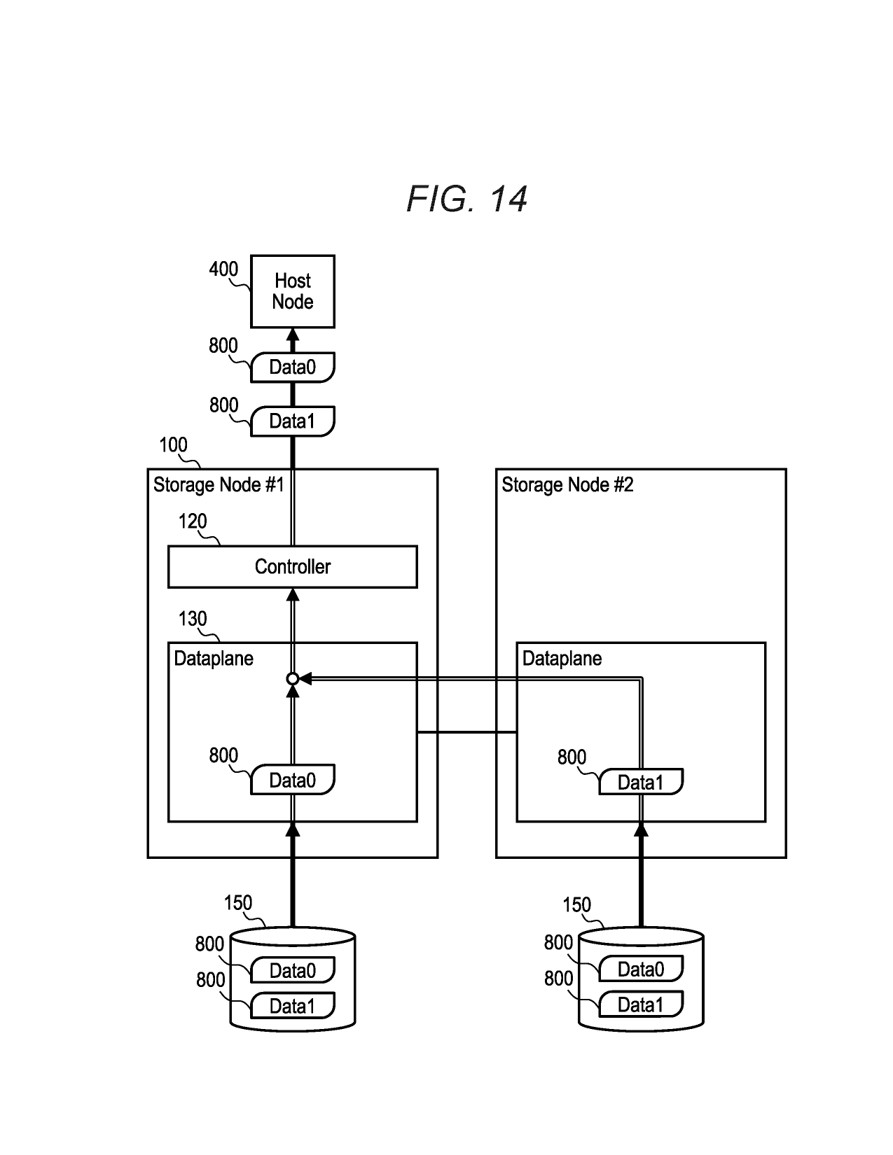

FIG. 14 is a diagram illustrating an outline of a parallel reading operation of a dual redundancy configuration according to the first embodiment. In the dual redundancy scheme, when a plurality of read requests arrive from the host node 400, the storage node 100 (#1) that has received the requests basically reads data from the storage medium 150 connected to the local node. However, the storage node 100 (#1) reads data from the storage medium 150 connected to another node (the storage node 100 (#2)) even during normal operation in a case where it is determined that the connection bandwidth of the local node with the backend network 620 has no remaining capacity and processing of another read request cannot be immediately executed. In the case of the N-fold redundancy scheme, one storage node 100 is selected from the N-1 other nodes having redundantly retained data, and data is read from the storage medium 150 of the selected storage node 100.

Parallel reading operation of distributed dual redundancy configuration according to first embodiment

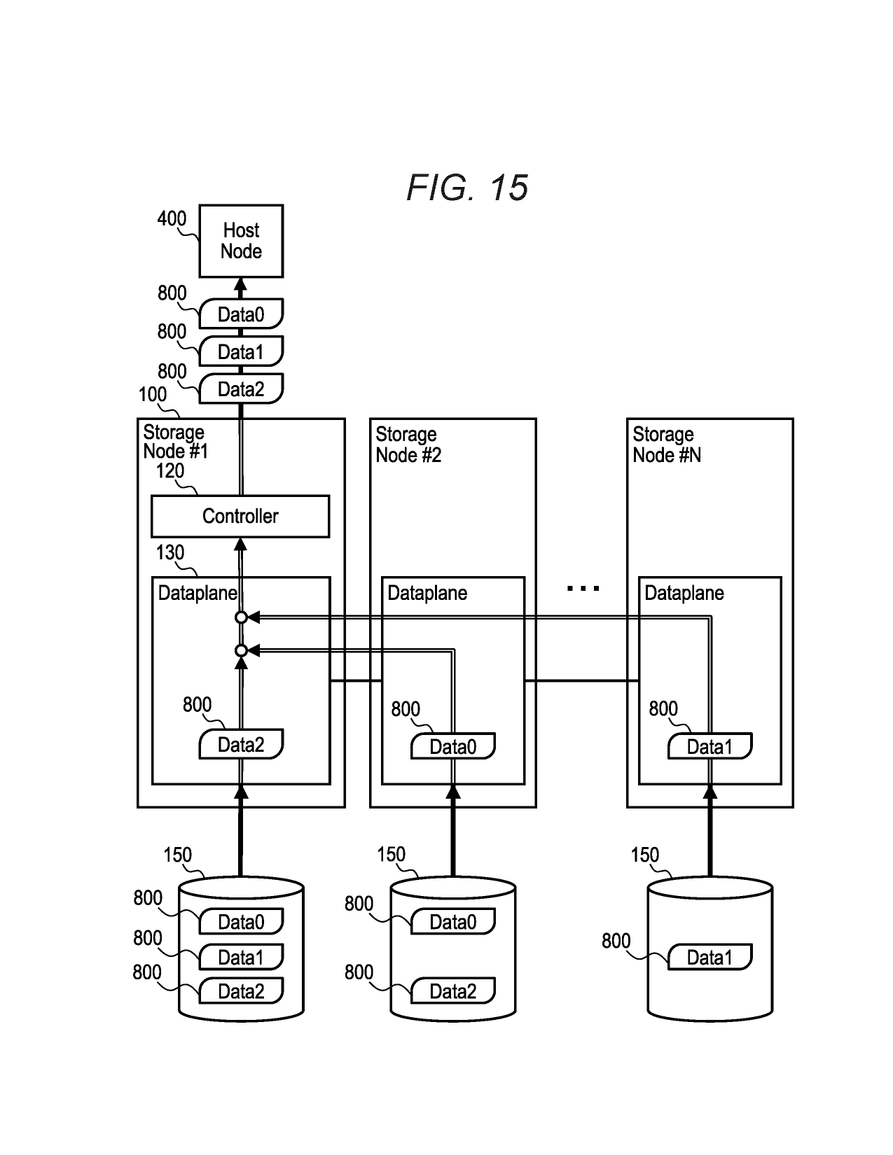

FIG. 15 is a diagram illustrating an outline of a parallel reading operation of a distributed dual redundancy configuration according to the first embodiment. Similarly to FIG. 14, in the distributed dual redundancy scheme, the storage node 100 (#1) that has received a plurality of read requests executes reading from the storage medium 150 of another node when the backend network bandwidth of the local node is insufficient. However, unlike the dual redundancy scheme of FIG. 14, other nodes retaining data redundantly are not fixed, and thus another node to execute reading is selected using an algorithm similar to the algorithm for determining the write destination at the time of writing. In the case of the N-fold redundancy scheme, one node is selected from the N-1 other nodes having redundantly retained data determined by the distributed algorithm, and data is read from the storage medium.

Parallel reading operation of erasure code redundancy configuration according to first embodiment

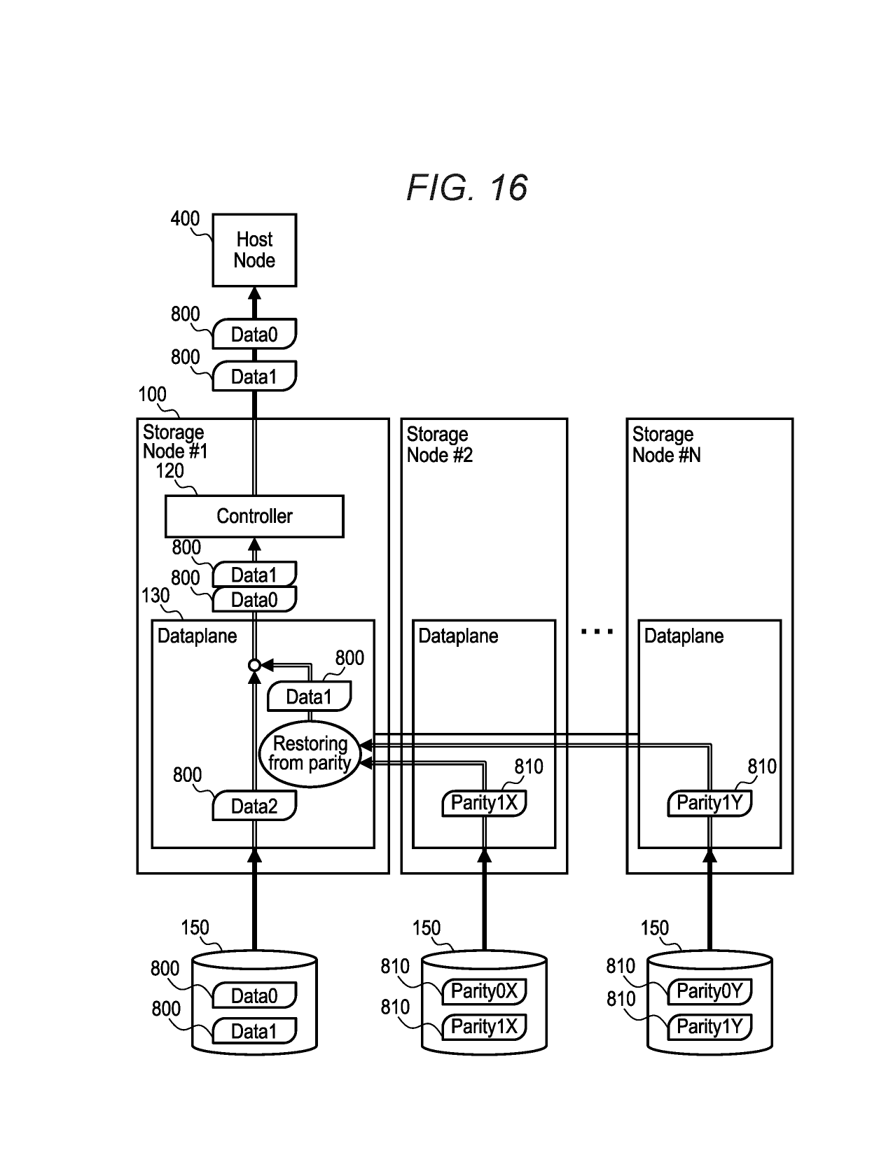

FIG. 16 is a diagram illustrating an outline of a parallel reading operation of an erasure code redundancy configuration according to the first embodiment. In the erasure coding redundancy scheme, when redundancy is made by the erasure code, the same data as the data retained by the local node does not exist in other nodes. For this reason, it is necessary to perform the restoration calculation from parity to restore the data. However, the operation is similar to that in FIGS. 14 and 15, and in a case where it is determined that there is no remaining capacity in the connection bandwidth with the backend network 610 of the local node and processing of another read request cannot be immediately executed, an operation of performing restoration calculation, generating original data from the parity, and responding to the host node 400 is executed.

According to the operation described with reference to FIGS. 14-16, in a case where the bandwidth of the backend network interface 540 is saturated when the read requests are concentrated on one storage node 100, data is read in cooperation with another node, and the limitation of the performance caused by the bandwidth limitation of the backend network interface 540 can be alleviated.

### Effects of first embodiment

In the first embodiment described above, a data read request is received from the host, and when no failure has occurred in the local node and the first storage drive, and the other node and the second storage drive, data is read in parallel using the bandwidth (backend bandwidth) of the backend network 610 of both the local node and the other node. Therefore, it is possible to improve the throughput and IOPS by effectively using the backend bandwidth that is likely to be subjected to a bandwidth shortage, and to improve the performance-to-cost ratio of the entire SDS cluster.

In the first embodiment described above, when the backend bandwidth of the local node is insufficient, data is read using the backend bandwidth of another node in which the backend bandwidth is not insufficient. Therefore, it is possible to acquire data reading performance exceeding the upper limit of the performance due to the constraint of the backend bandwidth per node of the storage node. In addition, in a situation where load is concentrated on one storage node, by using the resources of other nodes to which no load is applied, it is possible to improve the data reading performance up to the limit of the backend bandwidth in the entire SDS cluster and to improve the performance-to-cost ratio of the entire SDS cluster.

### Second Embodiment

In a second embodiment, in a case where a check code (verification code) for checking the presence or absence of data damage is added when redundantly storing data from a host node in a storage medium, load balancing performed by the cooperation of a load balancer and an observer when the load on a connection bandwidth with the storage medium becomes excessive will be described.

In the present embodiment, as a constraint condition of the backend network, a limit on the number of command executions per unit time is mainly taken into consideration. In the present embodiment, two or more read requests are issued to the backend side for data redundancy with respect to one read request received from the host node. Therefore, the command execution speed (IOPS) is likely to be limited before the bandwidth (throughput) is limited. Therefore, even if there is sufficient bandwidth, a case where it takes time to read data is likely to occur due to the limitation of the processing speed of the command.

Data writing operation and data retention status in dual redundancy configuration according to second embodiment

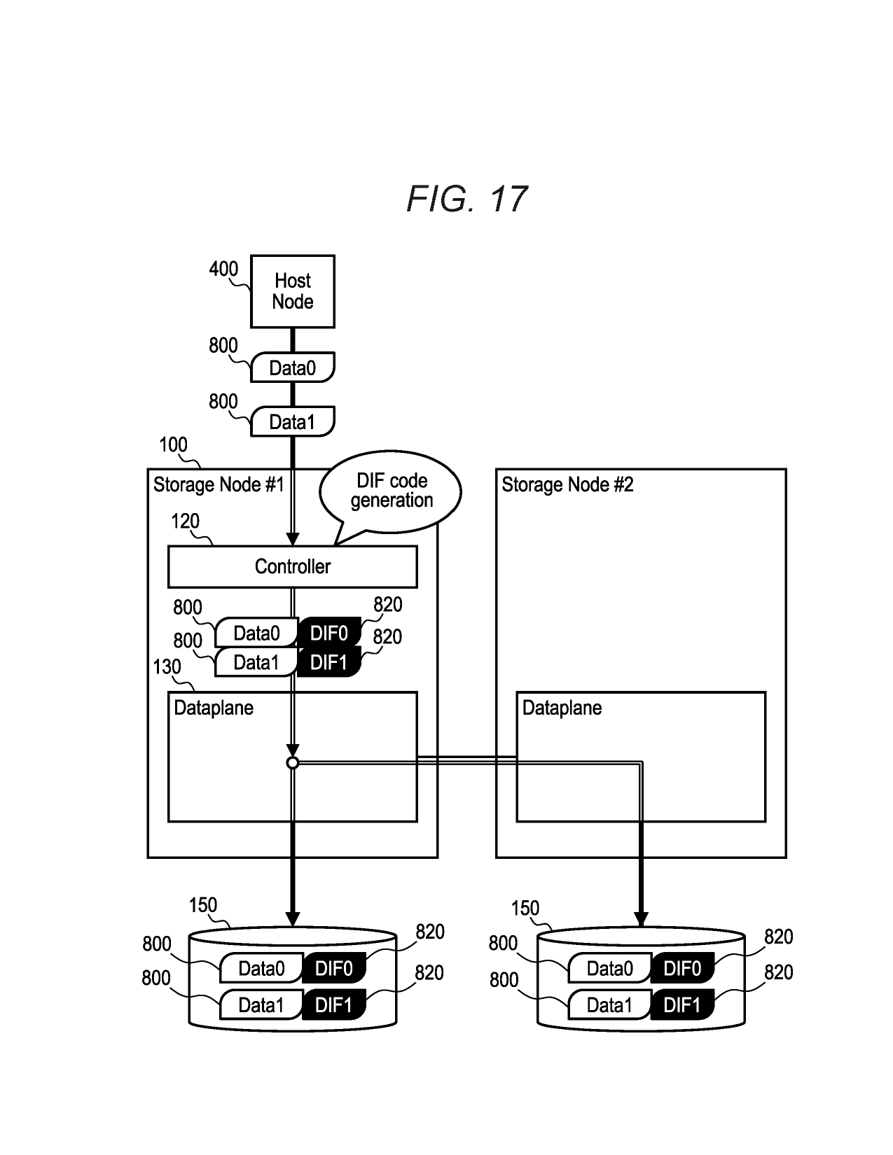

FIG. 17 is a diagram illustrating a data writing operation and a data retention status in a dual redundancy configuration according to the second embodiment.

FIG. 17 illustrates the case of the redundancy scheme by dual redundancy, but may be the case of the N-fold redundancy scheme (N ≥ 3), the distributed dual redundancy scheme, the distributed N-fold redundancy scheme (N ≥ 3), or the erasure coding scheme. In this case, the storage controller 120 adds a check code 820 to data 800 received from the host node 400 to verify the integrity of the data. The data plane function block 130 receives the data 800 to which the check code 820 is added, performs redundancy processing, and redundantly retains the data in the storage medium 150 connected to the local node. At this time, the data 800 and the check code 820 may be stored in the same storage medium 150, or may be stored in different storage media 150. The redundancy scheme and the storage location are determined according to a processing algorithm of the data plane function block 130.

Data reading operation at the time of failure in dual redundancy configuration according to second embodiment

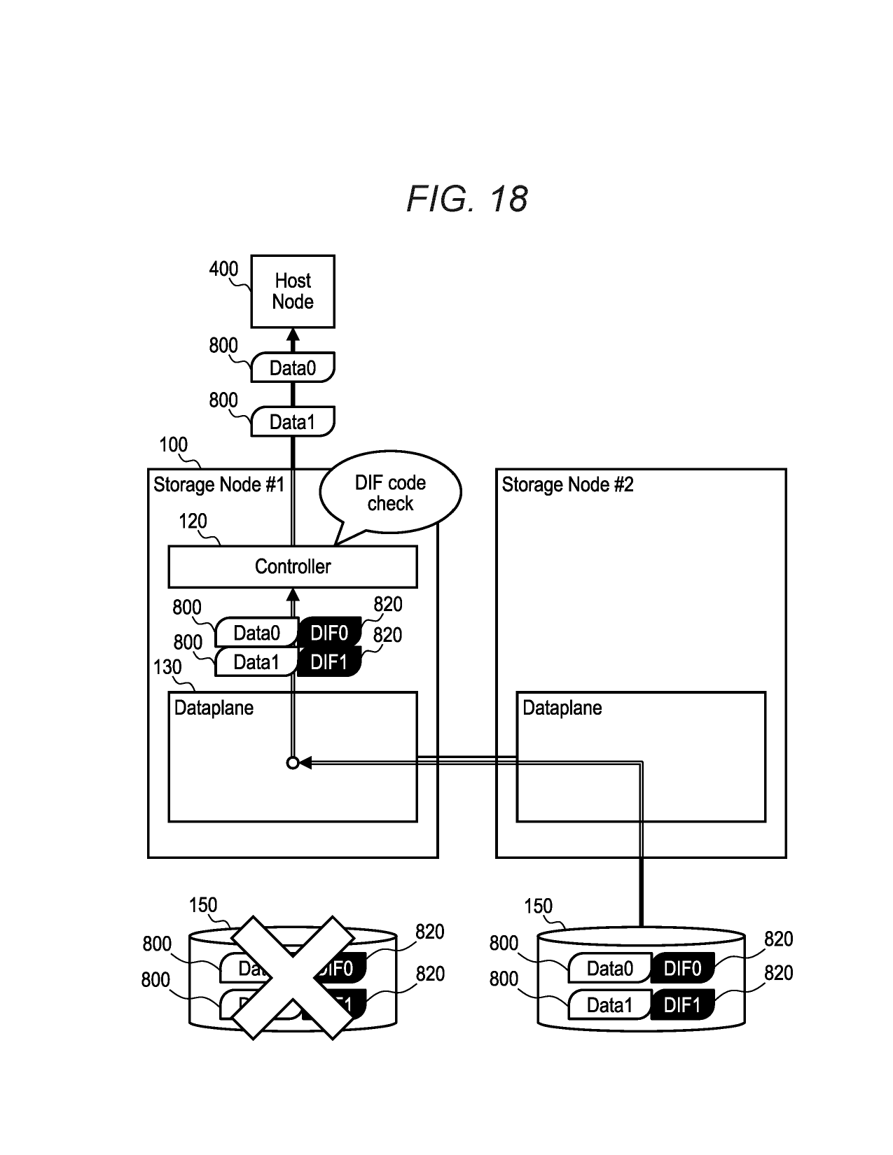

FIG. 18 is a diagram illustrating a data reading operation at the time of failure in a dual redundancy configuration according to the second embodiment. The data plane function block 130 of the storage node 100 (#1) requests the data plane function block 130 of another node to read both the data 800 and the check code 820 from the storage medium 150 connected to the other node when the storage medium 150 connected to the local node cannot be accessed. The data plane function block 130 of the other node reads the redundantly retained data 800 and the check code 820 from the storage medium 150 and transfers the data and the check code to the storage node 100 (#1) in response to the request.

The data plane function block 130 of the storage node 100 (#1) transfers the data 800 and the check code 820 transferred to the local node to the storage controller 120 of the local node. The storage controller 120 of the storage node 100 (#1) checks the integrity of the data 800 based on the check code 820. When the data 800 is not damaged, the storage controller 120 of the storage node 100 (#1) returns the data 800 to the host node 400 and completes the read processing. In contrast, when the data 800 is damaged, the storage controller 120 of the storage node 100 (#1) performs failure processing such as rereading for a predetermined number of times, and ultimately, if non-damaged data 800 cannot be obtained, returns an error to the host node 400 to complete the process.

Configuration of load balancer 200B according to second embodiment

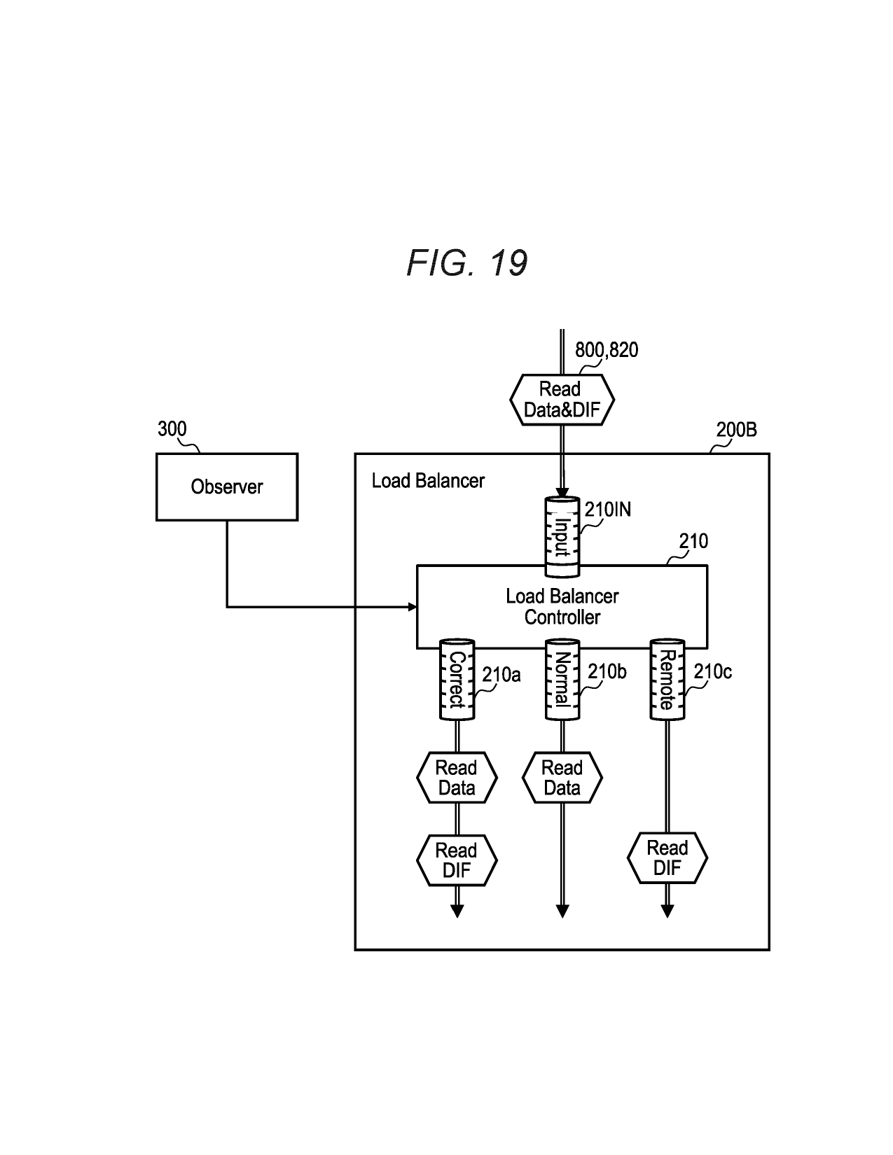

FIG. 19 is a diagram illustrating a configuration of a load balancer 200B according to the second embodiment. In the present embodiment, the storage node 100 includes a load balancer 200B instead of the load balancer 200. The load balancer 200B has the same configuration as the load balancer 200. The load balancer 200B differs from the load balancer 200 in that the read command is a command requesting reading of one or both of the data 800 and the check code 820.

When the load balancer 200B issues a request to the storage medium 150, it is executed in the data plane function block 130 after being split into a data read command and a check code read command. At this time, the data 800 and the check code 820 may be read from the storage medium 150 connected to the same storage node 100, or may be read from the storage medium 150 connected to different storage nodes 100.

Processing of load balancer 200B according to second embodiment

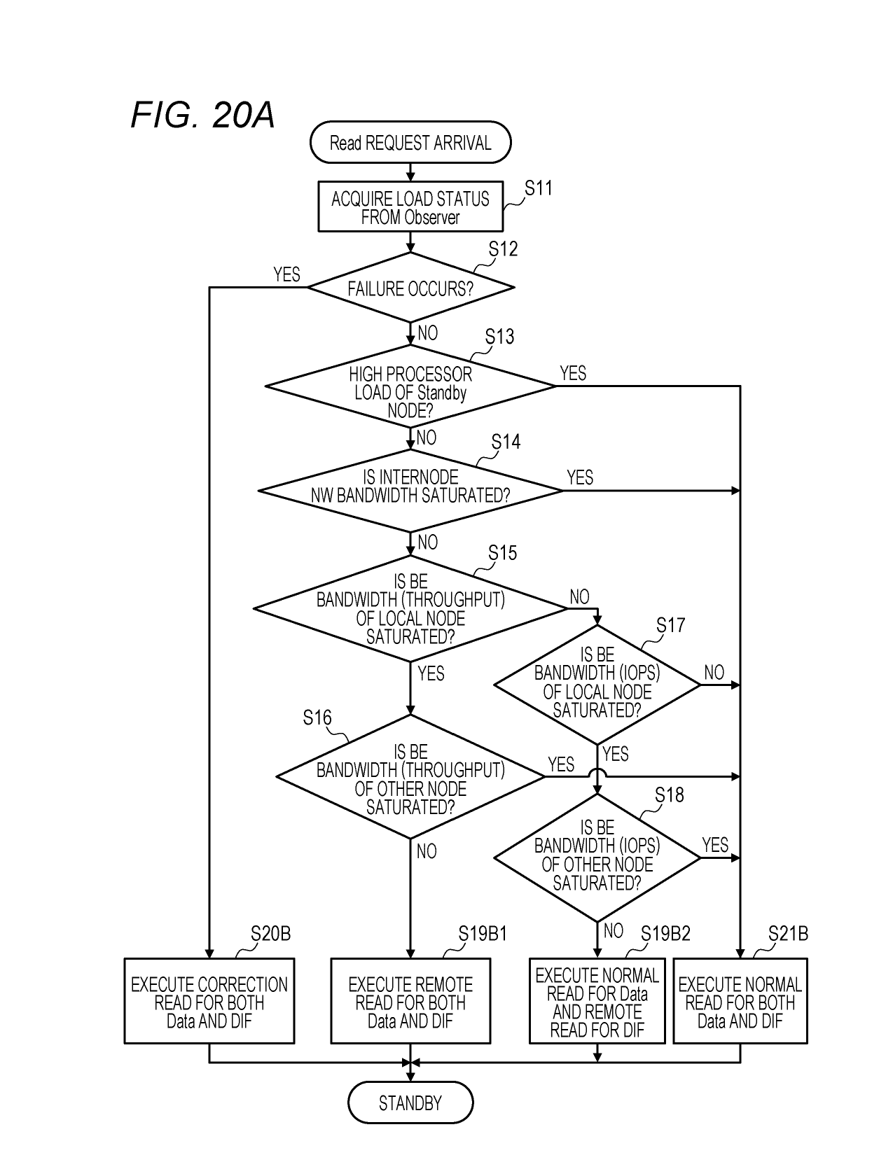

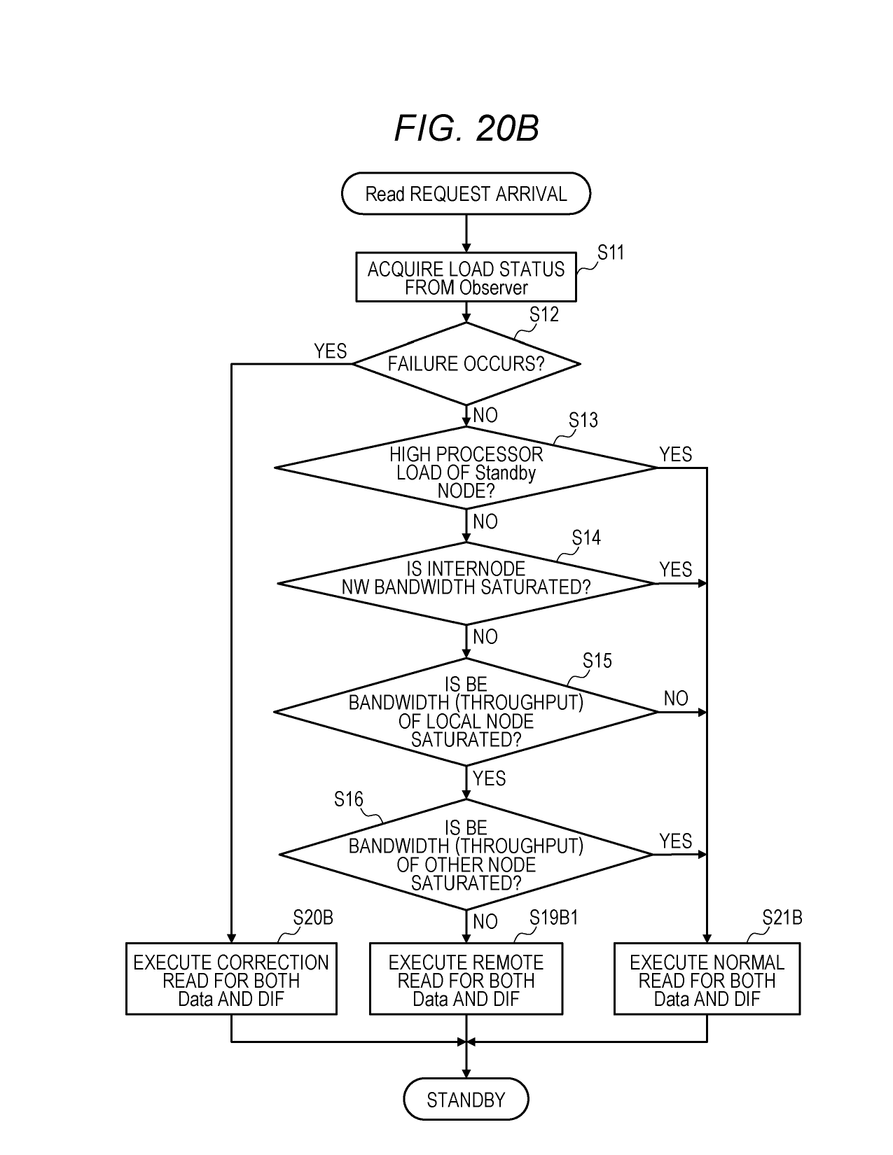

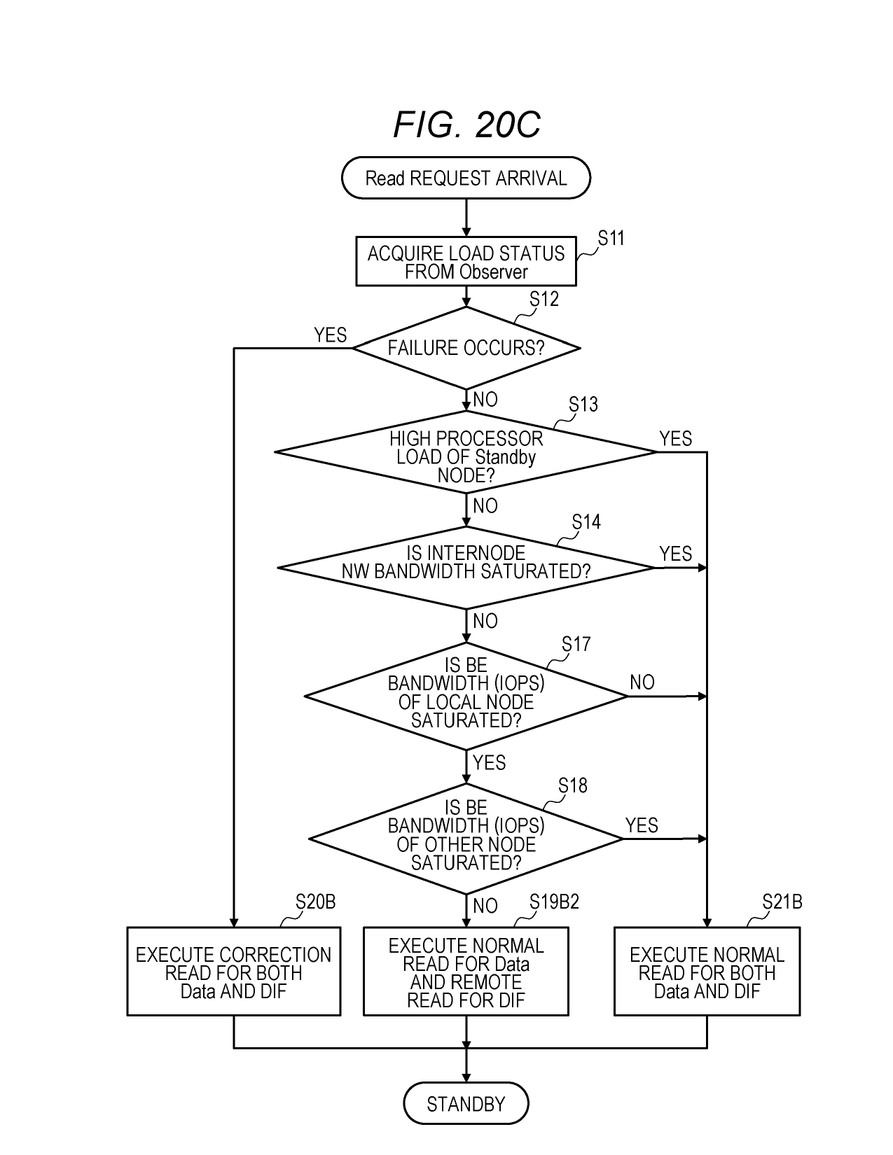

FIG. 20A is a flowchart illustrating processing of the load balancer 200B according to the second embodiment. In the processing of the load balancer 200B according to the second embodiment, as compared with the processing of the load balancer 200 according to the first embodiment, step S19B1 or S19B2 is executed instead of step S19, step S20B is executed instead of step S20, and step S21B is executed instead of step S21. Other processing of the load balancer 200B according to the second embodiment is similar to the processing of the load balancer 200 according to the first embodiment.

The load balancer controller 210 of the load balancer 200B moves the process to step S20B in a case of YES in step S12, and moves the process to step S13 in a case of NO in step S12. In addition, the load balancer controller 210 moves the process to step S21B in a case of YES in step S16, and moves the process to step S19B1 in a case of NO in step S16. In addition, the load balancer controller 210 moves the process to step S18 in a case of YES in step S17, and moves the process to step S21B in a case of NO in step S17. In addition, the load balancer controller 210 moves the process to step S21B in a case of YES in step S18, and moves the process to step S19B2 in a case of NO in step S18.

In step S21B, the load balancer controller 210 registers both the read commands of the data 800 and the check code 820 in the normal read queue 210b, and returns to the standby state. In step S20B, the load balancer controller 210 registers the read commands of both the data 800 and the check code 820 in the correction read queue 210a, and returns to the standby state. In step S19B1, the load balancer controller 210 registers the read commands of both the data 800 and the check code 820 in the remote read queue 210c, and returns to the standby state. In step S18B2, the load balancer controller 210 registers the read command of the data 800 in the normal read queue 210b and the read command of the check code 820 in the remote read queue 210c, and returns to the standby state. The read commands registered in the correction read queue 210a, the normal read queue 210b, and the remote read queue 210c are sequentially executed.

Note that, in the processing of the load balancer 200B described above with reference to FIG. 20A, the throughput and the IOPS are determined for the usage rates of the backend bandwidths of the storage nodes 100 of both the local node and the other node. However, the present invention is not limited thereto, and the usage rate of the backend bandwidth of the local node and the other node may be determined by only one of the throughput and the IOPS. The usage rates of the backend bandwidths of the local node and the other node will be described with reference to FIGS. 20B and 20C with the determination of only the throughput as a first modification of the second embodiment and the determination of only the IOPS as a second modification of the second embodiment.

FIG. 20B is a flowchart illustrating processing of a load balancer 200B according to the first modification of the second embodiment. In the processing of the load balancer 200B according to the first modification of the second embodiment, steps S17 and S18 are omitted as compared with the processing of the load balancer 200B illustrated in FIG. 20A. Then, the load balancer 200B moves the process to step S16 in a case of YES in step S15, and moves the process to step S21B in a case of NO in step S15. In addition, the load balancer 200B moves the process to step S21B in a case of YES in step S16, and moves the process to step S19B1 in a case of NO in step S16. The processing of the load balancer 200B according to the first modification of the second embodiment is similar to the processing of the load balancer 200B according to the second embodiment in other respects.

FIG. 20C is a flowchart illustrating processing of the load balancer 200B according to the second modification of the second embodiment. In the processing of the load balancer 200B according to the second modification of the second embodiment, steps S15 and S16 are omitted as compared with the processing of the load balancer 200B illustrated in FIG. 20A. In a case of NO in step S14, the load balancer 200B moves the process to step S17. The load balancer 200B moves the process to step S18 in a case of YES in step S17, and moves the process to step S21B in a case of NO in step S17. In addition, the load balancer 200B moves the process to step S21B

in a case of YES in step S18, and moves the process to step S19B2 in a case of NO in step S18. The processing of the load balancer 200B according to the second modification of the second embodiment is similar to the processing of the load balancer 200B according to the second embodiment in other respects.

In the present embodiment, when only one of the data 800 and the check code 820 is remotely read, the check code 820 is remotely read, but the data 800 may be remotely read. In general, the size of the data 800 is larger than that of the check code 820, and in a case where the data 800 is acquired from another node, the bandwidth of the inter-node network is consumed more than that in a case where the check code 820 is acquired. Therefore, by remotely reading the check code 820, consumption of the inter-node network bandwidth can be suppressed.

However, the determination may be made in consideration of the situation of the data transfer speed (throughput) for the BE bandwidths of the local node and another node at the time of execution of step S19B2. For example, in a case where the BE data transfer speed on the local node side is close to the upper limit and the BE data transfer speed on the other node side has remaining capacity, the operation may be such that a read command on the data side is registered in the remote read queue and a read on the check code side is registered in the normal read queue.

Outline of parallel reading operation of dual redundancy configuration according to second embodiment

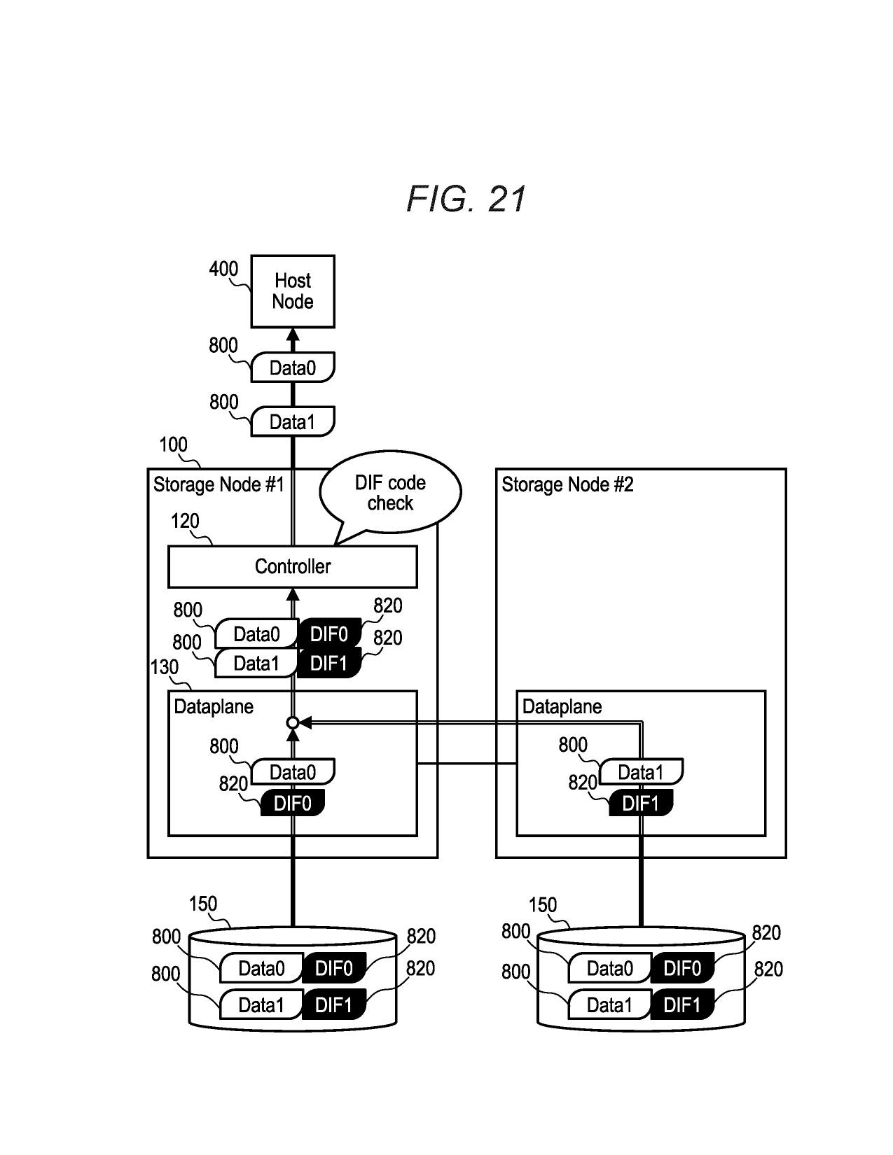

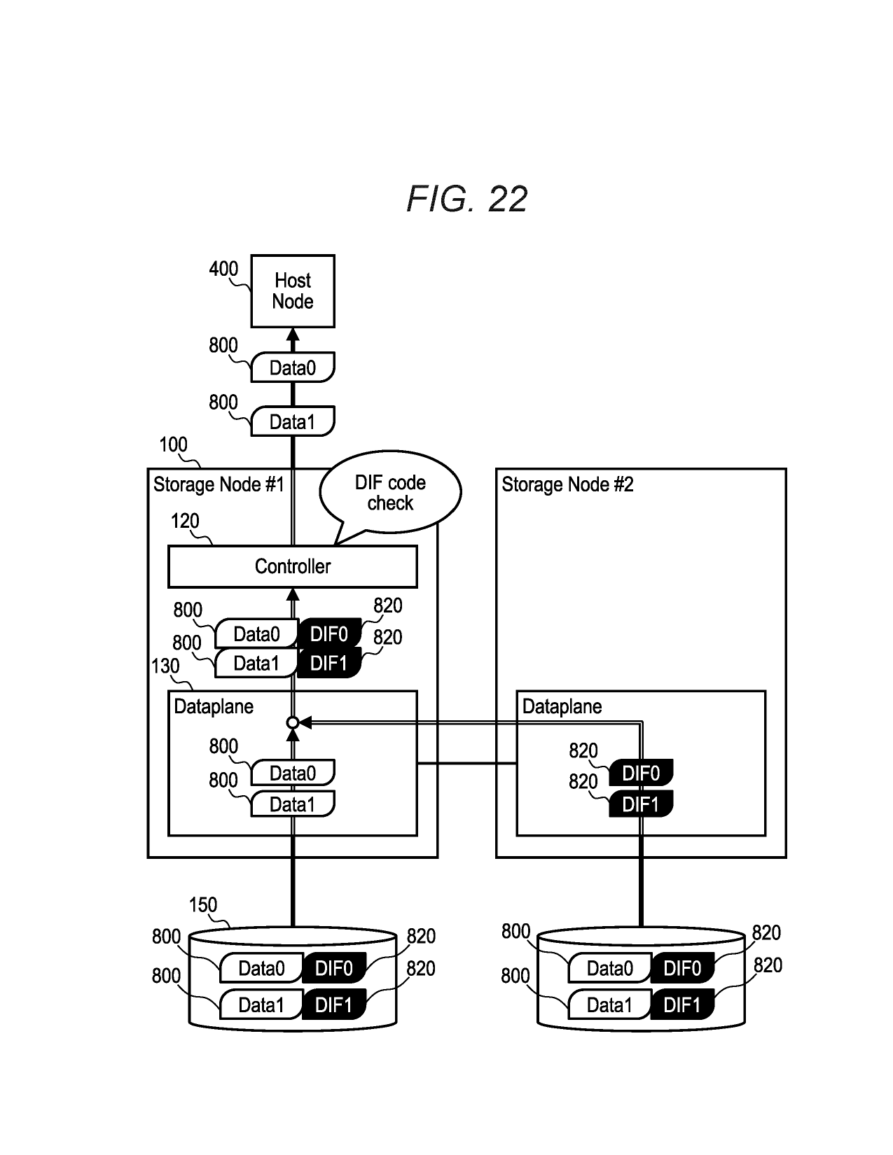

FIGS. 21 and 22 are diagrams illustrating an outline of the parallel reading operation of a dual redundancy configuration according to the second embodiment.

As illustrated in FIG. 21, in the storage node 100 (#1), the data plane function block 130 causes another node to read “Data 1” of the data 800 and “DIF1” of the check code 820 in a case where the data transfer speed of the BE bandwidth of the local node exceeds a threshold value. The data plane function block 130 reads “Data0” of the data 800 and “DIF0” of the check code 820 from the storage medium 150 of the local node. Then, the data plane function block 130 responds to the storage controller 120 with “Data 0” of the data 800, “DIF0” of the check code 820, “Data 1” of the data 800, and “DIF1” of the check code 820.

As described above, by reading the data 800 and the check code 820 from another node and transferring the data to the local node, it is possible to read the data beyond the restriction of the data transfer speed (throughput) of the BE bandwidth of the local node. The storage controller 120 receives the data 800 and the check code 820, regenerates the second check code from the data 800 by predetermined calculation, and transfers the data 800 to the host node 400 after confirming the integrity of the read data 800 by comparing with the read check code 820 (first check code).

In addition, as illustrated in FIG. 22, in the storage node 100 (#1), in a case where the command execution speed of the local node exceeds a threshold value for the BE bandwidth of the local node, the data plane function block 130 causes another node to read “DIF0” and “DIF1” of the check code 820. In addition, the data plane function block 130 reads “Data0” and “Data1” of the data 800 from the storage medium 150 of the local node. Then, the data plane function block 130 responds “Data0” and “Data1” of the data 800 and “DIF0” and “DIF1” of the check code 820 to the storage controller 120.

By reading the check code 820 from another node and transferring the read check code to the local node in this manner, it is possible to read data exceeding the restriction of the command execution speed (IPOS) of the BE bandwidth of the local node. For example, in a case where there is remaining capacity in the data transfer speed of the BE bandwidth but the number of executed commands is very large such that a large number of small-sized read requests are generated, the operation illustrated in FIG. 22 is executed, so that more read commands can be processed.

In the present embodiment, the dual redundancy configuration has been described. However, in other redundancy schemes such as the distributed dual redundancy configuration and the erasure code redundancy configuration described in the first embodiment, it is possible to similarly perform an operation of reading the data 800 and the check code 820 in a shared manner between the local node and another node.

Note that even in a case where the command execution speed (IOPS) is a constraint factor in the first embodiment, the operation may be implemented to be switched according to the saturation requirement of the command execution speed as in the second embodiment. In this case, since there is no check code, the read command of the data 800 is registered in the remote read queue 210c in both steps S19B1 and S19B2, and the read command of the data is transferred to another node and executed.

In addition, in the first and second embodiments, the method for switching the operation focusing on the data transfer speed and the command execution speed in the BE bandwidth has been described. However, the present invention is not limited thereto, and for example, a threshold value may be set to a characteristic that may be saturated, for example, a read delay time in the other backend network and the storage medium 150, and the operation may be switched according to a result of the threshold value determination.

### Effects of second embodiment

In the second embodiment described above, an effect similar to that of the first embodiment is obtained by switching the read destination of the data and the verification code to either the local node or another node according to the load status of the local node. Furthermore, in a case where the backend throughput of the local node is not insufficient but the IOPS performance is insufficient, it is possible to compensate for the insufficiency of the IOPS performance while maintaining the load balance between the nodes by reading data in the local node and reading the verification code in another node.

The present invention is not limited to the above-described embodiments, and includes various modifications. For example, the above-described embodiments have been described in detail in order to describe the present invention in an easy-to-understand manner, and are not necessarily limited to those having all the described configurations. In addition, a part of the configuration of a certain embodiment can be replaced with the configuration of another embodiment, and the configuration of another embodiment can be added to the configuration of a certain embodiment. In addition, it is possible to add, delete, and replace other configurations for a part of the configuration of each embodiment. In addition, some or all of the above-described configurations, functions, processing units, processing means, and the like may be realized by hardware, for example, by designing with an integrated circuit. In addition, each of the above-described configurations, functions, and the like may be realized by software by a processor interpreting and executing a program for realizing each function.

What is claimed is:

1. A storage system including a plurality of storage nodes communicably connected to a plurality of storage drives, wherein
each of the storage nodes includes a storage controller,
in a case where the storage controller receives a write request of data from a host,
the storage controller stores the data in a first storage drive of the storage drives and transfers redundant data of the data to another of the storage controllers, and
the other storage controller stores the redundant data transferred from the storage controller in a second storage drive of the storage drives,
in a case where a failure occurs in the first storage drive and a read request of data is received from the host, the other storage controller
reads the redundant data from the second storage drive and transfers the redundant data to the storage controller, and the storage controller responds to the host using the transferred redundant data, and
in a case where a read request of data is received from the host when a failure does not occur in the first storage drive, the storage controller selects and performs one of:
first read processing of reading the data from the first storage drive and responding to the host, and
second read processing of transferring the read request to the other storage controller and responding to the host using the redundant data of the data read and transferred from the second storage drive by the other storage controller in response to the read request.

2. The storage system according to claim 1, wherein
the storage controller selects whether to perform the first read processing or the second read processing for each read request.

3. The storage system according to claim 2, wherein
in a case where the second read processing is performed in response to the read request, the first read processing is performed in parallel in response to another read request.

4. The storage system according to claim 1, wherein
the storage controller selects whether to perform the first read processing or the second read processing using at least one of load on the storage controller or the other storage controller, and load on one of communication paths between the storage controller, the other storage controller, the first storage drive, and the second storage drive.

5. The storage system according to claim 4, wherein
the first read processing is performed in a case where load on the storage controller is low and load on a communication path between the storage controller and the first storage drive is low, and
the second read processing is performed in a case where load on the storage controller is high or load on a communication path between the storage controller and the first storage drive is high.

6. The storage system according to claim 1, wherein
a plurality of the other storage controllers and a plurality of the second storage drives are provided,
the redundant data of the data to be stored in the first storage drive is stored in a distributed manner in the plurality of the second storage drives, and
in the second read processing, the plurality of other storage controllers each read the redundant data from a corresponding one of the plurality of second storage drives and transfer the redundant data to the storage controller.

7. The storage system according to claim 6, wherein
the redundant data is parity, and
the storage controller restores the data using a plurality of pieces of the transferred parity and responds to the host.

8. The storage system according to claim 1, wherein
a verification code of the data is stored in the first storage drive and the second storage drive together with the data or the redundant data,
the storage controller checks the data using the verification code and then responds to the host, and
the storage controller selects whether to perform the first read processing or the second read processing for the verification code, separately from selecting whether to perform the first read processing or the second read processing for the data and the redundant data.

9. The storage system according to claim 8, wherein
the storage system selects and performs one of:
the first read processing in which the storage controller reads the data and the verification code from the first storage drive,
the second read processing in which the other storage controller reads and transfers the redundant data and the verification code from the second storage drive; and
third read processing in which the storage controller reads the data from the first storage drive, and the other storage controller reads the verification code from the second storage drive and transfers the verification code to the storage controller.

10. A method for controlling a storage system executed by a storage system including a plurality of storage nodes communicably connected to a plurality of storage drives, wherein
each of the storage nodes includes a storage controller, and
the method comprises operations in which
in a case where the storage controller receives a write request of data from a host,
the storage controller stores the data in a first storage drive of the storage drives and transfers redundant data of the data to another of the storage controllers, and
the other storage controller stores the redundant data transferred from the storage controller in a second storage drive of the storage drives,
in a case where a failure occurs in the first storage drive and a read request of data is received from the host, the other storage controller
reads the redundant data from the second storage drive and transfers the redundant data to the storage controller, and the storage controller responds to the host using the transferred redundant data,
in a case where a read request of data is received from the host when a failure does not occur in the first storage drive, the storage controller selects and performs one of:
first read processing of reading the data from the first storage drive and responding to the host, and
second read processing of transferring the read request to the other storage controller and responding to the host using the redundant data of the data read and transferred from the second storage drive by the other storage controller in response to the read request.
